(19) United States
(12) Patent Application Publication
(10) Pub. No.: US 2026/0226293 A1
(43) Pub. Date: Aug. 6, 2026

(54) CURABLE COMPOSITION, STRETCHABLE COATING LAYER USING THE SAME, STRETCHABLE SECONDARY BATTERY, FUEL CELL, AND STRETCHABLE TRANSISTOR USING STRETCHABLE COATING LAYER, WEARABLE DEVICE INCLUDING THE SAME, AND METHOD FOR MANUFACTURING CURABLE COMPOSITION

(71) Applicant: KOREA INSTITUTE OF SCIENCE AND TECHNOLOGY, Seoul (KR)

(72) Inventors: Jeong Gon SON, Seoul (KR); Sung Yeon BAE, Seoul (KR); Young Ho YOO, Seoul (KR); Hee Suk KIM, Seoul (KR); Tae Ann KIM, Seoul (KR); Jae Hong KIM, Seoul (KR); Kyung June CHO, Seoul (KR); Jung Hwan BYUN, Seoul (KR)

(73) Assignee: KOREA INSTITUTE OF SCIENCE AND TECHNOLOGY, Seoul (KR)

(21) Appl. No.: 19/260,948

(22) Filed: Jul. 7, 2025

(30) Foreign Application Priority Data
Jan. 31, 2025 (KR) 10-2025-0012491
May 27, 2025 (KR) 10-2025-0068649
May 28, 2025 (KR) 10-2025-0069899

(51) Int. Cl. C09D 5/24; C08K 5/1565; C08K 5/315; C08K 5/3445; C09D 7/20; C09D 7/63; C09D 127/16; C09D 127/20; H01M 4/62; H01M 10/0525

(52) U.S. Cl. CPC C09D 5/24; C08K 5/1565; C08K 5/315; C08K 5/3445; C09D 7/20; C09D 7/63; C09D 127/16; C09D 127/20; H01M 4/62; H01M 10/0525; H01M 2220/30

(57) ABSTRACT

According to the present invention, a method for manufacturing a curable composition may include: preparing a base solution by dissolving a fluorine-based polymer in a solvent; and preparing the curable composition by providing and dissolving lithium salt, an ionic liquid, succinonitrile, an azide-based curing agent, and an additive in the base solution.

A substrate (e.g., a stretchable polymer film, a carbon support, lithium foil, copper foil, a positive electrode in which a positive electrode layer is formed on a positive electrode current collector, or a negative electrode in which a negative electrode layer is formed on a negative electrode current collector) may be coated with the curable composition manufactured by the above method, and the curable composition may be cured with ultraviolet light, so that a stretchable coating layer having improved electrical and mechanical properties may be manufactured.

Therefore, the stretchable coating layer may be used as a solid electrolyte layer of a stretchable secondary battery, a channel layer of a stretchable transistor, and an electrolyte layer of a fuel cell, and the stretchable secondary battery, the stretchable transistor, and the fuel cell to which the stretchable coating layer is introduced may be applied to a wearable device.

### CROSS-REFERENCE TO RELATED APPLICATIONS

This application claims the benefit under 35 USC 119 (a) of Korean Patent Application Nos. 10-2025-0012491 filed on Jan. 31, 2025, 10-2025-0068649 filed on May 27, 2025, and 10-2025-0069899 filed on May 28, 2025, in the Korean Intellectual Property Office, the entire disclosures of which are incorporated herein by reference for all purposes.

### TECHNICAL FIELD

The present disclosure relates to a curable composition, a stretchable coating layer using the same, a stretchable secondary battery, a fuel cell, and a stretchable transistor using the stretchable coating layer, a wearable device including the same, and a method for manufacturing the curable composition, and more particularly, to a method for manufacturing a curable composition including a solvent, a fluorine-based polymer, lithium salt, an ionic liquid, succinonitrile, an azide-based curing agent, and an additive, a method for manufacturing a stretchable coating layer by using the curable composition, a stretchable coating layer, a secondary battery using the stretchable coating layer, a stretchable transistor using the stretchable coating layer, a fuel cell using the stretchable coating layer, and a wearable device including the secondary battery, the stretchable transistor, and the fuel cell.

### BACKGROUND ART

Recently, as demand for wearable electronic devices rapidly increases, interest has been focused on stretchable energy storage devices capable of flexibly responding to human body movements. In particular, stretchable secondary batteries that are applicable to various types of wearable devices such as garment-integrated sensors, skin-attached bio-devices, and electronic skin (e-skin) are attracting attention as a next-generation energy storage technology. In such application fields, flexibility and stretchability capable of maintaining stable electrochemical properties even under external mechanical deformation (tension, bending, etc.) as well as high energy density are essential.

Lithium-ion secondary batteries and lithium metal-based secondary batteries that have been used traditionally and widely are mainly based on liquid electrolytes. However, since the liquid electrolytes have a high possibility of liquid leakage, and organic solvents used have flammability, there may be a risk of fire or explosion. Such characteristics are emerging as even greater safety issues, especially in application environments such as wearable devices that make close contact with a human body as well as electric vehicles or large-capacity storage devices.

In addition, although lithium metal batteries having high energy density have been spotlighted as next-generation energy storage systems, a fire risk is structurally inherent in the lithium metal batteries due to characteristics of a lithium metal, so that development of solid electrolytes to compensate for the fire risk has to be carried out in parallel. However, a conventional solid electrolyte technology has faced several limitations.

First, dendrite may grow in a lithium metal electrode in a charge/discharge process, which may cause physical damage to the electrode or an internal short circuit, thereby causing serious safety problems. In addition, upon repeated charge/discharge, dead lithium may be accumulated due to repeated formation of a solid electrolyte interface (SEI), and coulombic efficiency and a lifespan of the battery may be reduced.

Although introduction of solid electrolytes has potential to alleviate such problems of liquid electrolytes, there may be limitations to commercialization due to low ionic conductivity and high interfacial contact resistance with the lithium metal. In particular, due to characteristics of a solid state, close contact with the electrode may be poor, which may cause inefficiency in ion transference and deterioration in overall battery performance.

In addition, polymer electrolytes may exhibit relatively lower ionic conductivity than organic electrolytes, and when an interface with the electrode is imperfect, it may be difficult to maintain long-term cycle performance. Such problems may emerge more under high-speed charge/discharge conditions, so that there may be significant technical limitations for application to commercial wearable devices.

Therefore, development of a new-concept curable composition capable of ensuring safety and maintaining high ionic conductivity while obtaining flexibility and stretchability and a stretchable coating layer based on the curable composition is emerging as a key task for commercializing wearable devices including stretchable secondary batteries.

### DOCUMENTS OF RELATED ART

### Patent Documents

(Patent Document 0001) Korean Unexamined Patent Publication No. 10-2023-0138754

### DISCLOSURE

### Technical Problem

One technical object of the present invention is to provide a curable composition capable of improving lithium ion conductivity of a stretchable coating layer.

Another technical object of the present invention is to provide a curable composition capable of improving stretchability, mechanical properties, and adhesive strength of a stretchable coating layer.

Still another technical object of the present invention is to provide a method for manufacturing a stretchable secondary battery with an improved rate determination characteristic.

Yet another technical object of the present invention is to provide a method for manufacturing a stretchable secondary battery with improved long-term stability for charge/discharge cycles.

Still yet another technical object of the present invention is to provide a method for manufacturing a stretchable secondary battery, in which a manufacturing process cost is reduced.

Another technical object of the present invention is to provide a method for manufacturing a stretchable secondary battery, in which a manufacturing time is shortened.

Still another technical object of the present invention is to provide a method for manufacturing a stretchable secondary battery, in which mass production is facilitated.

Technical objects of the present invention are not limited to the technical objects described above.

### Technical Solution

To achieve the technical objects described above, the present invention provides a method for manufacturing a curable composition.

According to one embodiment, the method for manufacturing the curable composition includes: preparing a base solution by dissolving a fluorine-based polymer in a solvent; and preparing the curable composition by providing and dissolving lithium salt, an ionic liquid, succinonitrile, an azide-based curing agent, and an additive in the base solution.

According to one embodiment, the solvent may include one of dimethyl carbonate, acetone, or acetonitrile.

According to one embodiment, the fluorine-based polymer may include at least one of polyvinylidene fluoride, poly(vinylidene fluoride-co-hexafluoropropylene), polytetrafluoroethylene (PTFE), or tetrafluoroethylene-co-hexafluoropropylene.

According to one embodiment, the azide-based curing agent may include at least one of 2,6-bis(4-azidobenzylidene)cyclohexanone, ethane-1,2-diyl bis(4-azido-2,3,5,6-tetrafluorobenzoate), polyoxyethylene bis(azide), or (2,2-bis(((4-azido-2,3,5,6-tetrafluorobenzoyl)oxy)methyl)propane-1,3-diyl bis(4-azido-2,3,5,6-tetrafluorobenzoate).

According to one embodiment, the ionic liquid may include at least one of 1-ethyl-3-methylimidazolium bis(trifluoromethylsulfonyl)imide, 1-butyl-1-methylpyrrolidinium bis(fluorosulfonyl)imide, N-methyl-N-propylpiperidinium hexafluorophosphate, or tetraethylanmonium tetrafluoroborate.

According to one embodiment, the lithium salt may include lithium bis(trifluoromethanesulfonyl)imide, and the additive may include fluoroethylene carbonate.

According to one embodiment, a chain of the fluorine-based polymer may have fluidity upon swelling so that ionic conductivity of the fluorine-based polymer may be improved, the ionic liquid may allow the fluorine-based polymer to swell so that the ionic conductivity of the fluorine-based polymer may be improved, the succinonitrile may have a plastic crystal at a room temperature so that a lithium ion transference number may be increased, and the azide-based curing agent may include at least two azides.

According to one embodiment, the azide of the azide-based curing agent may be converted into a nitrene intermediate by ultraviolet light or heat, and the nitrene intermediate may react with the fluorine-based polymer, the succinonitrile, positive ions of the ionic liquid, and a C—H bond of the additive so as to form a secondary amine bond.

According to one embodiment, ionic conductivity, a lithium ion transference number, and lithium ion conductivity of a stretchable coating layer formed by curing the curable composition may be controlled according to a weight ratio of the ionic liquid and the succinonitrile in the curable composition.

According to one embodiment, as the weight ratio of the ionic liquid in the curable composition increases, the ionic conductivity of the stretchable coating layer may be gradually improved.

According to one embodiment, as the weight ratio of the succinonitrile in the curable composition increases, the lithium ion transference number of the stretchable coating layer may be gradually increased.

According to one embodiment, the weight ratio of the ionic liquid and the succinonitrile in the curable composition may be controlled to be greater than 1:1 and less than 1:3, so that the lithium ion conductivity of the stretchable coating layer may be improved.

According to one embodiment, the ionic liquid may include 1-ethyl-3-methylimidazolium bis(trifluoromethylsulfonyl)imide.

To achieve the technical objects described above, the present invention provides a method for manufacturing a stretchable coating layer by using the curable composition manufactured by the manufacturing method described above.

According to one embodiment, the method for manufacturing the stretchable coating layer includes: preparing the curable composition; forming a preliminary stretchable coating layer by coating a substrate with the curable composition and evaporating a solvent; and preparing the stretchable coating layer by irradiating the preliminary stretchable coating layer with ultraviolet light, wherein the curable composition includes the solvent, a fluorine-based polymer, lithium salt, an ionic liquid, succinonitrile, an azide-based curing agent, and an additive, and ionic conductivity of the stretchable coating layer is controlled according to an irradiation time of the ultraviolet light with which the preliminary stretchable coating layer is irradiated.

According to one embodiment, the irradiation time of the ultraviolet light may be controlled to be greater than 60 seconds and less than 180 seconds, so that the ionic conductivity of the stretchable coating layer may be controlled.

According to one embodiment, an azide of the azide-based curing agent may be converted into a nitrene intermediate in a process of irradiating the preliminary stretchable coating layer with the ultraviolet light, and the nitrene intermediate may react with the fluorine-based polymer, the succinonitrile, positive ions of the ionic liquid, and a C—H bond of the additive so as to form a secondary amine bond, so that the fluorine-based polymer, the succinonitrile, the positive ions of the ionic liquid, and the additive may be crosslinked into a single network.

According to one embodiment, lithium ion conductivity of the stretchable coating layer may be controlled according to a weight ratio of the ionic liquid and the succinonitrile in the curable composition.

According to one embodiment, the weight ratio of the ionic liquid and the succinonitrile in the curable composition may be controlled to be greater than 1:1 and less than 1:3, so that the lithium ion conductivity of the stretchable coating layer may be improved.

According to one embodiment, the substrate may include one of a stretchable polymer film, a carbon support, lithium foil, copper foil, a positive electrode in which a positive electrode layer is formed on a positive electrode current collector, or a negative electrode in which a negative electrode layer is formed on a negative electrode current collector.

According to one embodiment, adhesive strength between the substrate and the stretchable coating layer may be stronger in a case where the substrate is the lithium foil than in a case where the substrate is the copper foil.

To achieve the technical objects described above, the present invention provides a stretchable coating layer manufactured by the manufacturing method described above.

According to one embodiment, there is provided the stretchable coating layer in which a fluorine-based polymer, succinonitrile, positive ions of an ionic liquid, and an additive are crosslinked into a single network by a nitrene intermediate, wherein ionic conductivity of the stretchable coating layer is greater than or equal to 4.90 mS/cm, a lithium ion transference number (t_{Li+}) of the stretchable coating layer is greater than or equal to 0.644, and lithium ion conductivity of the stretchable coating layer is greater than or equal to 3.16 mS/cm.

According to one embodiment, the fluorine-based polymer may include poly(vinylidene fluoride-co-hexafluoropropylene), the ionic liquid may include 1-ethyl-3-methylimidazolium bis(trifluoromethylsulfonyl)imide, the additive may include fluoroethylene carbonate, and the stretchable coating layer may further include lithium salt.

According to one embodiment, a Young's modulus value of the stretchable coating layer may be greater than or equal to 10.2 MPa, a maximum extension rate of the stretchable coating layer may be greater than or equal to 120%, a recovery rate may be greater than or equal to 75% upon removal of a load after the stretchable coating layer is stretched by 40%, and adhesive strength between the stretchable coating layer and lithium foil may be stronger than adhesive strength between the stretchable coating layer and copper foil.

To achieve the technical objects described above, the present invention provides a method for manufacturing a stretchable secondary battery by using the method for manufacturing the stretchable coating layer described above.

According to one embodiment, the method for manufacturing the stretchable secondary battery includes: preparing a curable composition; preparing a positive electrode and a negative electrode; forming a stretchable coating layer by coating the positive electrode with the curable composition, evaporating a solvent, and irradiating the curable composition with ultraviolet light; forming a stretchable coating layer by coating the negative electrode with the curable composition, evaporating a solvent, and irradiating the curable composition with ultraviolet light; and preparing the stretchable secondary battery by arranging the stretchable coating layer formed on the positive electrode and the stretchable coating layer formed on the negative electrode to face each other so as to make contact with each other and applying pressure, wherein the curable composition includes the solvent, a fluorine-based polymer, lithium salt, an ionic liquid, succinonitrile, an azide-based curing agent, and an additive, an azide of the azide-based curing agent is converted into a nitrene intermediate in a process of irradiating the curable composition with the ultraviolet light, and the nitrene intermediate reacts with the fluorine-based polymer, the succinonitrile, positive ions of the ionic liquid, and a C—H bond of the additive so as to form a secondary amine bond, so that the stretchable coating layer in which the fluorine-based polymer, the succinonitrile, the positive ions of the ionic liquid, and the additive are crosslinked into a single network is formed.

To achieve the technical objects described above, the present invention provides a stretchable transistor using the stretchable coating layer described above.

According to one embodiment, the stretchable coating layer described above may be used as a channel layer of the stretchable transistor.

To achieve the technical objects described above, the present invention provides a fuel cell using the stretchable coating layer described above.

According to one embodiment, the stretchable coating layer described above may be used as an electrolyte layer of the fuel cell.

To achieve the technical objects described above, the present invention provides a wearable device including the stretchable secondary battery, the stretchable transistor, and the fuel cell described above.

According to one embodiment, the wearable device may include at least one of the stretchable secondary battery, the stretchable transistor, and the fuel cell described above.

### Advantageous Effects

According to the present invention, a method for manufacturing a curable composition may include: preparing a base solution by dissolving a fluorine-based polymer in a solvent; and preparing the curable composition by providing and dissolving lithium salt, an ionic liquid, succinonitrile, an azide-based curing agent, and an additive in the base solution.

In the preparing of the curable composition, a weight ratio of the ionic liquid and the succinonitrile in the curable composition may be controlled to be greater than 1:1 and less than 1:3. Accordingly, a stretchable coating layer with improved lithium ion conductivity can be provided.

In detail, a method for manufacturing the stretchable coating layer may include: preparing the curable composition; forming a preliminary stretchable coating layer by coating a substrate with the curable composition and evaporating the solvent; and preparing the stretchable coating layer by irradiating the preliminary stretchable coating layer with ultraviolet light.

In the preparing of the curable composition, a weight ratio of the ionic liquid and the succinonitrile in the curable composition may be controlled to be greater than 1:1 and less than 1:3. In addition, in the preparing of the stretchable coating layer (101), an irradiation time of the ultraviolet light with which the preliminary stretchable coating layer is irradiated may be controlled to be greater than 60 seconds and less than 180 seconds.

Accordingly, a crosslinking level of the fluorine-based polymer, the succinonitrile, positive ions of the ionic liquid, and the additive can be optimized by the azide-based curing agent in the preliminary stretchable coating layer, so that a stretchable coating layer with improved lithium ion conductivity, stretchability, mechanical properties, and adhesive strength with the substrate can be provided.

Accordingly, the stretchable coating layer can be used as a solid electrolyte layer of a stretchable secondary battery, a channel layer of a stretchable transistor, and an electrolyte layer of a fuel cell. Therefore, the stretchable secondary battery, the stretchable transistor, and the fuel cell can be applied to a wearable device.

### DESCRIPTION OF DRAWINGS

FIG. 1 is a flowchart for describing a method for manufacturing a curable composition according to an embodiment of the present invention.

FIG. 2 is a view for describing a scheme of preparing a base solution according to the embodiment of the present invention.

FIG. 3 is a view for describing a scheme of preparing the curable composition according to the embodiment of the present invention.

FIG. 4 is a view for describing a method for manufacturing a stretchable coating layer according to an embodiment of the present invention.

FIG. 5 is a view for describing a scheme of forming a stretchable coating layer on a positive electrode according to the embodiment of the present invention.

FIG. 6 is a view for describing a scheme of forming a stretchable coating layer on a negative electrode according to the embodiment of the present invention.

FIG. 7 is a view for describing a method for manufacturing a stretchable secondary battery according to an embodiment of the present invention.

FIG. 8 is a view for describing a step of preparing a stretchable secondary battery by arranging a positive electrode and a negative electrode according to a modified example of the present invention.

FIG. 9 shows FT-IR analysis results before/after ultraviolet light irradiation of a solid electrolyte source according to Experimental Example 1 of the present invention.

FIG. 10 shows differential scanning calorimetry (DSC) analysis results for succinonitrile and a mixture according to an experimental example of the present invention.

FIG. 11 shows differential scanning calorimetry (DSC) analysis results before/after the ultraviolet light irradiation of the solid electrolyte source according to Experimental Example 1 of the present invention.

FIG. 12 shows stress-strain curves of solid electrolyte layers according to experimental examples of the present invention.

FIG. 13 shows a SEM photograph of a solid electrolyte layer on a negative electrode in a coin cell according to Experimental Example 1 of the present invention.

FIG. 14 is a graph obtained by measuring adhesive strength of solid electrolyte layers according to experimental examples of the present invention.

FIG. 15 is a graph for comparing ionic conductivity of a solid electrolyte layer according to a time of ultraviolet light with which the solid electrolyte source according to Experimental Example 1 of the present invention is irradiated.

FIG. 16 is a graph showing a lithium ion transference number t_{Li+} for a freestanding solid electrolyte layer prepared by using the solid electrolyte source according to Experimental Example 1 of the present invention.

FIG. 17 is a graph for comparing electrochemical properties before/after the ultraviolet light irradiation of the solid electrolyte source according to Experimental Example 1 of the present invention.

FIG. 18 is a graph for comparing bulk resistance R_{b} and interfacial resistance Ri of symmetric cells according to experimental examples of the present invention.

FIG. 19 is a graph for comparing performance of symmetric cells according to experimental examples of the present invention.

FIG. 20 is a graph obtained by measuring critical current density of a symmetric cell according to Experimental Example 2 of the present invention.

FIG. 21 shows SEM photographs of solid electrolyte layers after charge/discharge cycles of symmetric cells according to experimental examples of the present invention.

FIG. 22 is a graph for comparing performance of coin cells according to Experimental Examples 1 to 3 of the present invention.

FIG. 23 is a graph showing a voltage profile according to charge/discharge cycles of the coin cell according to Experimental Example 1 of the present invention.

FIG. 24 is a graph for comparing charge/discharge cycle performance of the coin cells according to Experimental Examples 1 and 2 of the present invention.

FIG. 25 is a graph showing a voltage profile according to charge/discharge cycles of the coin cell according to Experimental Example 1 of the present invention.

FIG. 26 is a graph showing a rate determination characteristic of the coin cell according to Experimental Example 1 of the present invention.

FIG. 27 is a graph showing a voltage profile according to rate determination of the coin cell according to Experimental Example 1 of the present invention.

FIG. 28 is a graph for describing charge/discharge cycle performance of a coin cell according to Experimental Example 4 of the present invention.

FIG. 29 is a graph for describing a rate determination characteristic of the coin cell according to Experimental Example 4 of the present invention.

FIG. 30 is a graph for describing charge/discharge cycle performance of a pouch cell according to Experimental Example 1 of the present invention.

FIG. 31 is a graph showing a voltage profile for charge/discharge cycles of the pouch cell according to Experimental Example 1 of the present invention.

FIG. 32 is a graph for describing a rate determination characteristic of the pouch cell according to Experimental Example 1 of the present invention.

FIG. 33 is a graph for describing charge/discharge cycle performance of a pouch cell according to Experimental Example 2 of the present invention.

FIG. 34 is a graph for describing battery performance after cutting the pouch cell according to Experimental Example 1 of the present invention.

FIG. 35 shows actual photographs of the pouch cell according to Experimental Example 1 of the present invention, which is bent with various radii of curvature.

FIG. 36 is a graph for describing performance of the cell after bending the pouch cell according to Experimental Example 1 of the present invention with various radii of curvature.

FIG. 37 shows stress-strain curves of a solid electrolyte layer according to an experimental example of the present invention.

FIG. 38 is a graph for comparing ionic conductivity for freestanding solid electrolyte layers prepared by using solid electrolyte sources according to experimental examples of the present invention.

FIG. 39 is a graph for comparing lithium ion transference numbers t_{Li+} for freestanding solid electrolyte layers prepared by using solid electrolyte sources according to experimental examples of the present invention.

FIG. 40 is a graph for comparing lithium ion conductivity for freestanding solid electrolyte layers prepared by using solid electrolyte sources according to experimental examples of the present invention.

FIG. 41 is a graph for evaluating interfacial stability of a symmetric cell according to Experimental Example 2 of the present invention.

FIG. 42 is a view for describing XPS analysis results for an electrode surface after charge/discharge of the symmetric cell according to Experimental Example 2 of the present invention.

FIG. 43 is a graph for describing performance of a coin cell according to Experimental Example 5 of the present invention.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural layer form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of layers of elements.

Further, in the following description of the present invention, detailed descriptions of known functions or configurations incorporated herein will be omitted when they may make the gist of the present invention unnecessarily unclear.

### Method for Manufacturing Curable Composition According to Embodiment of Present Invention

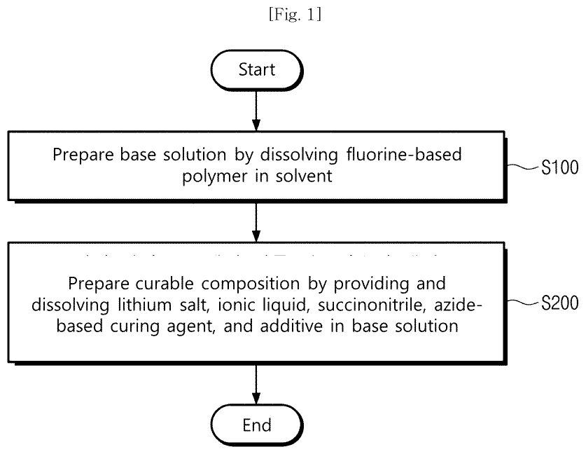

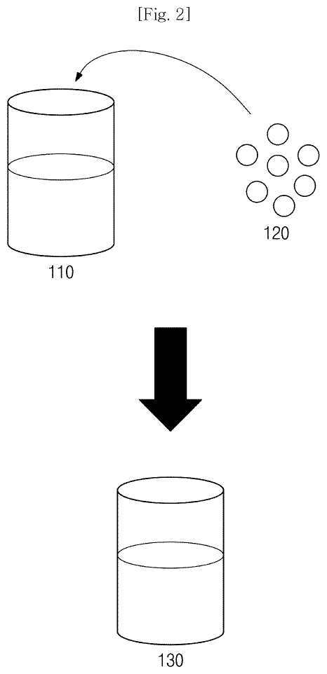

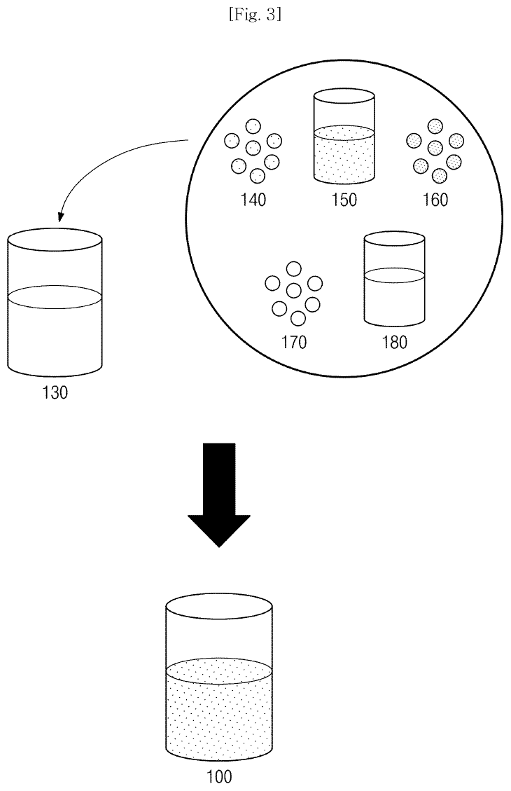

FIG. 1 is a flowchart for describing a method for manufacturing a curable composition according to an embodiment of the present invention, FIG. 2 is a view for describing a scheme of preparing a base solution according to the embodiment of the present invention, and FIG. 3 is a view for describing a scheme of preparing the curable composition according to the embodiment of the present invention.

Referring to FIGS. 1 and 2, a base solution 130 may be prepared by dissolving a fluorine-based polymer 120 in a solvent 110 (S100).

In the preparing of the base solution, the solvent 110 may be, for example, one of dimethyl carbonate, acetone, or acetonitrile. For a specific example, the solvent 110 may be dimethyl carbonate.

In addition, a chain of the fluorine-based polymer 120 may have fluidity upon swelling so that ionic conductivity of the fluorine-based polymer 120 may be improved. For example, the fluorine-based polymer 120 may be one of polyvinylidene fluoride, poly(vinylidene fluoride-co-hexafluoropropylene), polytetrafluoroethylene (PTFE), or tetrafluoroethylene-co-hexafluoropropylene.

Referring to FIGS. 1 and 3, a curable composition 100 may be prepared by providing and dissolving lithium salt 140, an ionic liquid 150, succinonitrile 160, an azide-based curing agent 170, and an additive 180 in the base solution 130 (S200).

In the preparing of the curable composition 100, the lithium salt 140 may be, for example, lithium bis(trifluoromethanesulfonyl)imide.

In addition, the ionic liquid 150 may allow the fluorine-based polymer 120 to swell in the base solution 130 so that the ionic conductivity of the fluorine-based polymer 120 may be improved. For example, the ionic liquid 140 may be one of 1-ethyl-3-methylimidazolium bis(trifluoromethylsulfonyl) imide, 1-butyl-1-methylpyrrolidinium bis(fluorosulfonyl)imide, N-methyl-N-propylpiperidinium hexafluorophosphate, or tetraethylammonium tetrafluoroborate.

In addition, the succinonitrile 160 may have a plastic crystal at a room temperature so that a lithium ion transference number may be increased.

In addition, the azide-based curing agent 170 may include at least two azides. For example, the azide-based curing agent 170 may be one of 2,6-bis(4-azidobenzylidene)cyclohexanone, ethane-1,2-diyl bis(4-azido-2,3,5,6-tetrafluorobenzoate), polyoxyethylene bis(azide), or (2,2-bis(((4-azido-2,3,5,6-tetrafluorobenzoyl)oxy)methyl)propane-1,3-diyl bis(4-azido-2,3,5,6-tetrafluorobenzoate).

In addition, the additive 180 may be, for example, fluoroethylene carbonate.

Therefore, when ultraviolet light or heat is provided to the curable composition 100, the azide of the azide-based curing agent 170 may be converted into a nitrene intermediate while releasing nitrogen gas. As a result, the nitrene intermediate may react with the fluorine-based polymer 120, the succinonitrile 160, positive ions of the ionic liquid 150, and a C—H bond of the additive 180 so as to form a secondary amine bond. Accordingly, the fluorine-based polymer 120, the succinonitrile 160, the positive ions of the ionic liquid 150, and the additive 180 may be crosslinked into a single network, thereby forming a stretchable coating layer that will be described below.

In addition, in the preparing of the curable composition 100, ionic conductivity, a lithium ion transference number, and lithium ion conductivity of a stretchable coating layer may be controlled according to a weight ratio of the ionic liquid 150 and the succinonitrile 160 in the curable composition 100.

In detail, as the weight ratio of the ionic liquid 150 in the curable composition 100 increases, the ionic conductivity of the stretchable coating layer may be gradually improved. In addition, as the weight ratio of the succinonitrile 160 in the curable composition 100 increases, the lithium ion transference number of the stretchable coating layer may be gradually increased.

According to one embodiment, the weight ratio of the ionic liquid 150 and the succinonitrile 160 in the curable composition 100 may be controlled to be greater than 1:1 and less than 1:3. Accordingly, the lithium ion conductivity of the stretchable coating layer may be improved.

In contrast, when the weight ratio of the ionic liquid 150 and the succinonitrile 160 in the curable composition 100 is controlled to be less than or equal to 1:1, or greater than or equal to 1:3, the lithium ion conductivity of the stretchable coating layer may be reduced.

Therefore, according to an embodiment of the present disclosure, the weight ratio of the ionic liquid 150 and the succinonitrile 160 in the curable composition 100 may be controlled to be greater than 1:1 and less than 1:3. Accordingly, the stretchable coating layer with improved lithium ion conductivity may be provided.

In conclusion, according to an embodiment of the present disclosure, a method for manufacturing the curable composition 100 may include: preparing the base solution 130 by dissolving the fluorine-based polymer 120 in the solvent 110; and preparing the curable composition 100 by providing and dissolving the lithium salt 140, the ionic liquid 150, the succinonitrile 160, the azide-based curing agent 170, and the additive 180 in the base solution 130.

In the preparing of the curable composition 100, the weight ratio of the ionic liquid 150 and the succinonitrile 160 in the curable composition 100 may be controlled to be greater than 1:1 and less than 1:3. Accordingly, the stretchable coating layer with improved lithium ion conductivity may be provided.

### Method for Manufacturing Stretchable Coating Layer According to Embodiment of Present Invention

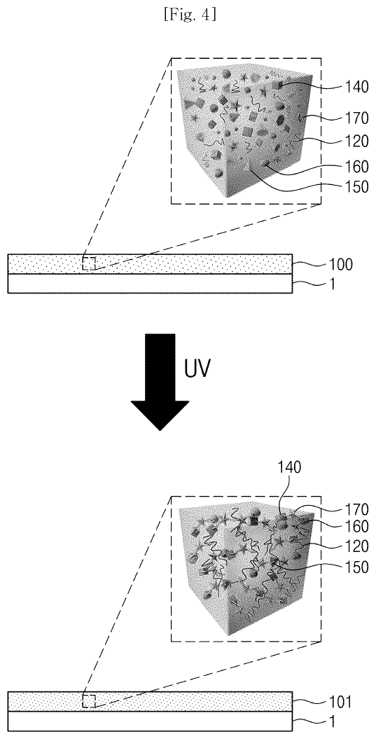

FIG. 4 is a view for describing a method for manufacturing a stretchable coating layer according to an embodiment of the present invention.

Referring to FIGS. 1 to 4, a method for manufacturing a stretchable coating layer 101 will be described.

The method for manufacturing the stretchable coating layer 101 may include: preparing a curable composition 100; forming a preliminary stretchable coating layer by coating a substrate 1 with the curable composition 100 and evaporating a solvent; and preparing the stretchable coating layer 101 by irradiating the preliminary stretchable coating layer with ultraviolet light.

In the preparing of the curable composition 100, the curable composition 100 may be prepared by the method described above with reference to FIGS. 1 to 3.

Therefore, the curable composition 100 may include a solvent 110, a fluorine-based polymer 120, lithium salt 140, an ionic liquid 150, succinonitrile 160, an azide-based curing agent 170, and an additive 180. For example, the solvent 110 may be dimethyl carbonate. For example, the fluorine-based polymer 120 may be poly(vinylidene fluoride-co-hexafluoropropylene). For example, the lithium salt 140 may be lithium bis(trifluoromethanesulfonyl)imide. For example, the ionic liquid 150 may be 1-ethyl-3-methylimidazolium bis(trifluoromethylsulfonyl) imide. For example, the azide-based curing agent 170 may be 2,6-bis(4-azidobenzylidene)cyclohexanone. For example, the additive 180 may be fluoroethylene carbonate.

Accordingly, lithium ion conductivity of the stretchable coating layer 101 may be controlled according to a weight ratio of the ionic liquid 150 and the succinonitrile 160 in the curable composition 100.

According to one embodiment, the weight ratio of the ionic liquid 150 and the succinonitrile 160 in the curable composition 100 may be controlled to be greater than 1:1 and less than 1:3. Accordingly, the lithium ion conductivity of the stretchable coating layer 101 may be improved.

In contrast, when the weight ratio of the ionic liquid 150 and the succinonitrile 160 in the curable composition 100 is controlled to be less than or equal to 1:1, or greater than or equal to 1:3, the lithium ion conductivity of the stretchable coating layer 101 may be reduced.

Therefore, according to an embodiment of the present disclosure, the weight ratio of the ionic liquid 150 and the succinonitrile 160 in the curable composition 100 may be controlled to be greater than 1:1 and less than 1:3. Accordingly, the stretchable coating layer 101 with improved lithium ion conductivity may be provided.

In addition, in the preparing of the preliminary stretchable coating layer, the curable composition 100 may be provided in a liquid state on the substrate 1, so that the substrate 1 may be coated in close contact with the curable composition 100. In other words, the substrate 1 may be conformally coated with the curable composition 100. For example, the substrate 1 may be one of a stretchable polymer film, a carbon support, lithium foil, copper foil, a positive electrode in which a positive electrode layer is formed on a positive electrode current collector, or a negative electrode in which a negative electrode layer is formed on a negative electrode current collector. For example, adhesive strength between the substrate 1 and the stretchable coating layer 101 may be stronger in a case where the substrate 1 is the lithium foil than in a case where the substrate 1 is the copper foil.

In addition, in the preparing of the stretchable coating layer 101, the ultraviolet light may be provided to the preliminary stretchable coating layer. Accordingly, in the preliminary stretchable coating layer, the azide of the azide-based curing agent 170 may be converted into a nitrene intermediate while releasing nitrogen gas. Accordingly, the nitrene intermediate may react with the fluorine-based polymer 120, the succinonitrile 160, positive ions of the ionic liquid 150, and a C—H bond of the additive 180 so as to form a secondary amine bond. Accordingly, the fluorine-based polymer 120, the succinonitrile 160, the positive ions of the ionic liquid 150, and the additive 180 may be crosslinked into a single network so as to form a three-dimensional network structure, and may be chemically bonded to the substrate 1 so that the adhesive strength between the substrate 1 and the stretchable coating layer 101 may be improved. Accordingly, a state in which the substrate 1 is coated in close contact with the curable composition 100 may be maintained. As a result, stretchability and mechanical properties of the stretchable coating layer 101, and adhesive strength between the stretchable coating layer 101 and the substrate 1 may be improved.

In addition, in the preparing of the stretchable coating layer 101, ionic conductivity of the stretchable coating layer 101 may be controlled according to an irradiation time of the ultraviolet light with which the preliminary stretchable coating layer is irradiated. For example, a wavelength of the ultraviolet light may be 365 nm. For example, an intensity of the ultraviolet light may be 0.7 W/cm².

According to one embodiment, the irradiation time of the ultraviolet light with which the preliminary stretchable coating layer is irradiated may be controlled to be greater than 60 seconds and less than 180 seconds. Accordingly, a crosslinking level of the fluorine-based polymer 120, the succinonitrile 160, positive ions of the ionic liquid 150, and the additive 180 may be optimized by the azide-based curing agent 170 in the preliminary stretchable coating layer. As a result, crystallinity of the fluorine-based polymer 120, the succinonitrile 160, the positive ions of the ionic liquid 150, and the additive 180 may be reduced, so that the ionic conductivity of the stretchable coating layer 101 may be improved.

In contrast, when the irradiation time of the ultraviolet light with which the preliminary stretchable coating layer is irradiated is controlled to be less than or equal to 60 seconds, or greater than or equal to 180 seconds, due to the azide-based curing agent 170 in the preliminary stretchable coating layer, the crosslinking level of the fluorine-based polymer 120, the succinonitrile 160, the positive ions of the ionic liquid 150, and the additive 180 may be reduced, or the crosslinking level may become excessive. As a result, the ionic conductivity of the stretchable coating layer 101 may be reduced.

Therefore, according to the embodiment of the present disclosure, the irradiation time of the ultraviolet light with which the preliminary stretchable coating layer is irradiated may be controlled to be greater than 60 seconds and less than 180 seconds. Accordingly, the crosslinking level of the fluorine-based polymer 120, the succinonitrile 160, the positive ions of the ionic liquid 150, and the additive 180 may be optimized by the azide-based curing agent 170 in the preliminary stretchable coating layer. Accordingly, the crystallinity of the fluorine-based polymer 120, the succinonitrile 160, the positive ions of the ionic liquid 150, and the additive 180 may be reduced, so that the stretchable coating layer 101 with improved ionic conductivity may be provided.

In conclusion, according to an embodiment of the present disclosure, the method for manufacturing the stretchable coating layer 101 may include: preparing the curable composition 100; forming the preliminary stretchable coating layer by coating the substrate 1 with the curable composition 100 and evaporating the solvent 110; and preparing the stretchable coating layer 101 by irradiating the preliminary stretchable coating layer with the ultraviolet light.

In the preparing of the curable composition 100, the weight ratio of the ionic liquid 150 and the succinonitrile 160 in the curable composition 100 may be controlled to be greater than 1:1 and less than 1:3. In addition, in the preparing of the stretchable coating layer 101, the irradiation time of the ultraviolet light with which the preliminary stretchable coating layer is irradiated may be controlled to be greater than 60 seconds and less than 180 seconds.

Accordingly, the crosslinking level of the fluorine-based polymer 120, the succinonitrile 160, the positive ions of the ionic liquid 150, and the additive 180 may be optimized by the azide-based curing agent 170 in the preliminary stretchable coating layer, so that the stretchable coating layer 101 with improved lithium ion conductivity, stretchability, mechanical properties, and adhesive strength with the substrate 1 may be provided. For example, ionic conductivity of the stretchable coating layer 101 may be greater than or equal to 4.90 mS/cm. For example, a lithium ion transference number t_{Li+} of the stretchable coating layer 101 may be greater than or equal to 0.644. For example, lithium ion conductivity of the stretchable coating layer 101 may be greater than or equal to 3.16 mS/cm. For example, a Young's modulus value of the stretchable coating layer 101 may be greater than or equal to 10.2 MPa. For example, a maximum extension rate of the stretchable coating layer 101 may be greater than or equal to 120%. For example, a recovery rate may be greater than or equal to 75% upon removal of a load after the stretchable coating layer 101 is stretched by 40%. For example, adhesive strength between the stretchable coating layer 101 and lithium foil may be 34.6 J/m² or more. For example, adhesive strength between the stretchable coating layer and copper foil may be 31.4 J/m² or more.

Accordingly, the stretchable coating layer 101 may be used as a solid electrolyte layer of a stretchable secondary battery, a channel layer of a stretchable transistor, and an electrolyte layer of a fuel cell. Therefore, the stretchable secondary battery, the stretchable transistor, and the fuel cell may be applied to a wearable device.

### Method for Manufacturing Stretchable Secondary Battery According to Embodiment of Present Invention

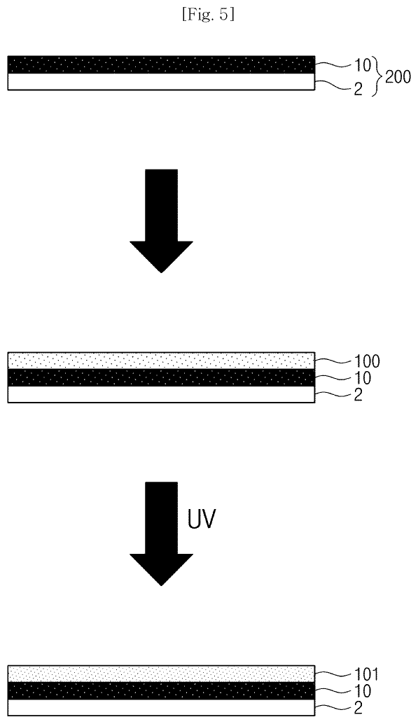

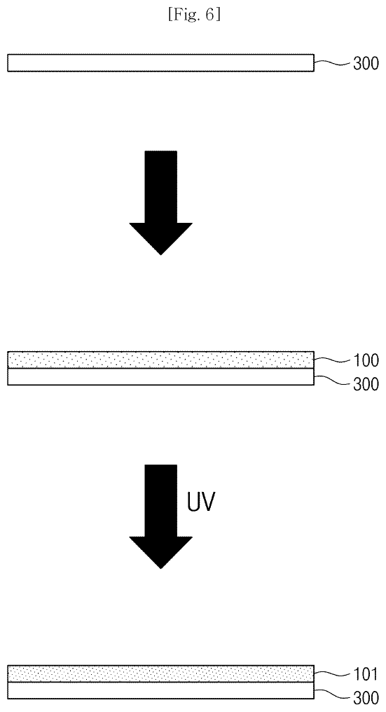

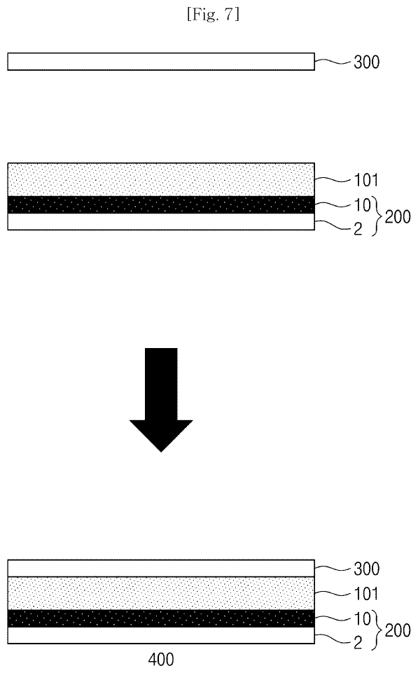

FIG. 5 is a view for describing a scheme of forming a stretchable coating layer on a positive electrode according to the embodiment of the present invention, FIG. 6 is a view for describing a scheme of forming a stretchable coating layer on a negative electrode according to the embodiment of the present invention, and FIG. 7 is a view for describing a method for manufacturing a stretchable secondary battery according to an embodiment of the present invention.

Referring to FIGS. 1 to 7, a method for manufacturing a stretchable secondary battery 400 will be described.

The method for manufacturing the stretchable secondary battery 400 may include: preparing a curable composition 100; preparing a positive electrode 200 and a negative electrode 300; forming a stretchable coating layer 101 by coating the positive electrode 200 with the curable composition 100, evaporating a solvent 110, and irradiating the curable composition 100 with ultraviolet light; forming a stretchable coating layer 101 by coating the negative electrode 300 with the curable composition 100, evaporating a solvent 110, and irradiating the curable composition 100 with ultraviolet light; and preparing the stretchable secondary battery 400 by arranging the stretchable coating layer 101 formed on the positive electrode 200 and the stretchable coating layer 101 formed on the negative electrode 300 to face each other so as to make contact with each other and applying pressure.

In the preparing of the curable composition 100, the curable composition 100 may be prepared by the method described above with reference to FIGS. 1 to 3.

Therefore, the curable composition 100 may include a solvent 110, a fluorine-based polymer 120, lithium salt 140, an ionic liquid 150, succinonitrile 160, an azide-based curing agent 170, and an additive 180. For example, the solvent 110 may be dimethyl carbonate. For example, the fluorine-based polymer 120 may be poly(vinylidene fluoride-co-hexafluoropropylene). For example, the lithium salt 140 may be lithium bis(trifluoromethanesulfonyl)imide. For example, the ionic liquid 150 may be 1-ethyl-3-methylimidazolium bis(trifluoromethylsulfonyl) imide. For example, the azide-based curing agent 170 may be 2,6-bis(4-azidobenzylidene) cyclohexanone. For example, the additive 180 may be fluoroethylene carbonate.

In addition, in the preparing of the positive electrode 200 and the negative electrode 300, as shown in FIG. 5, the positive electrode 200 may include a positive electrode current collector 2 and a positive electrode layer 10, and the positive electrode layer 10 may include a positive electrode active material, a conductive material, and a binder. For example, the positive electrode current collector 2 may be aluminum foil. For example, the positive electrode active material may be LiFePO₄ (LFP) or LiNi_{0.8}Co_{0.1}Mn_{0.1}O₂ (NCM). For example, the conductive material may be single wall carbon nanotube (SWCNT). For example, the binder may be polyvinylidene fluoride. In addition, as shown in FIG. 6, the negative electrode 300 may be metal foil. For example, the negative electrode 300 may be lithium foil.

In addition, in the forming of the stretchable coating layer 101 by coating the positive electrode 200 with the curable composition 100, evaporating the solvent 110, and irradiating the curable composition 100 with the ultraviolet light, the curable composition 100 may be in a liquid state, so that a surface of the positive electrode layer 10 of the positive electrode 200 may be coated in close contact with the curable composition 100. In other words, the surface of the positive electrode layer 10 of the positive electrode 200 may be conformally coated with the curable composition 100. Accordingly, the preliminary stretchable coating layer obtained by evaporating the solvent 110 in the curable composition 100 may also be maintained in close contact with the surface of the positive electrode layer 10 of the positive electrode 200, and the stretchable coating layer 101 obtained by curing the preliminary stretchable coating layer by the ultraviolet light may also be maintained in close contact with the surface of the positive electrode layer 10 of the positive electrode 200. In other words, there may be substantially no gap at an interface between the stretchable coating layer 101 and the positive electrode layer 10 of the positive electrode 200. Accordingly, interfacial stability between the positive electrode layer 10 of the positive electrode 200 and the stretchable coating layer 101 may be significantly improved.

Thereafter, when the ultraviolet light is provided to the preliminary stretchable coating layer, the azide of the azide-based curing agent 170 may be converted into a nitrene intermediate in the preliminary stretchable coating layer while releasing nitrogen gas. Therefore, the nitrene intermediate may react with the fluorine-based polymer 120, the succinonitrile 160, positive ions of the ionic liquid 150, and a C—H bond of the additive 180 so as to form a secondary amine bond. Accordingly, the fluorine-based polymer 120, the succinonitrile 160, the positive ions of the ionic liquid 150, and the additive 180 may be crosslinked into a single network so as to form a three-dimensional network structure, and may be chemically bonded to the positive electrode layer 10 of the positive electrode 200 so that adhesive strength between the positive electrode layer 10 of the positive electrode 200 and the stretchable coating layer 101 may be improved. As a result, stretchability and mechanical properties of the stretchable coating layer 101, and adhesive strength between the stretchable coating layer 101 and the positive electrode layer 10 of the positive electrode 200 may be improved. In addition, when the ultraviolet light is provided to the preliminary stretchable coating layer, a crosslinking level of the fluorine-based polymer 120, the succinonitrile 160, positive ions of the ionic liquid 150, and the additive 180 may be optimized by the azide-based curing agent 170 in the preliminary stretchable coating layer. Accordingly, crystallinity of the fluorine-based polymer 120, the succinonitrile 160, the positive ions of the ionic liquid 150, and the additive 180 may be reduced, so that the ionic conductivity of the stretchable coating layer 101 may be improved. Moreover, since the stretchable coating layer 101 has a three-dimensional network structure, flux of lithium ions may be uniformly formed upon charging/discharging of the stretchable secondary battery 400.

In addition, since the forming of the stretchable coating layer 101 by coating the negative electrode 300 with the curable composition 100, evaporating the solvent 110, and irradiating the curable composition 100 with the ultraviolet light has the same technical effects as a scheme of forming the stretchable coating layer 101 on the surface of the positive electrode layer 10 of the positive electrode 200, descriptions thereof will be omitted. In particular, reaction with the negative electrode 300 formed of lithium may be suppressed by the solvent 110 in the curable composition 100 with which the negative electrode 300 is coated. In other words, the negative electrode 300 may be formed of lithium so as to have significantly higher reactivity than other metals, and the reaction between the negative electrode 300 and the curable composition 100 may be suppressed by the solvent 110 in the curable composition 100. Accordingly, a surface of the negative electrode 300 may be coated in close contact with the curable composition 100. In other words, the surface of the negative electrode 300 may be conformally coated with the curable composition 100.

In addition, in the preparing of the stretchable secondary battery 400 by arranging the stretchable coating layer 101 formed on the positive electrode 200 and the stretchable coating layer 101 formed on the negative electrode 300 to face each other so as to make contact with each other and applying pressure, the stretchable secondary battery 400 may be easily prepared by applying pressure that is lower than pressure applied when assembling a conventional secondary battery while the stretchable coating layer 101 formed on the positive electrode 200 and the stretchable coating layer 101 formed on the negative electrode 300 are arranged to face each other so as to make contact with each other.

The stretchable secondary battery 400 manufactured by the above method may have a structure in which the positive electrode 200, the stretchable coating layer 101, and the negative electrode 300 are sequentially stacked. Accordingly, due to interfacial properties, electrical properties, and mechanical properties of the stretchable coating layer 101 of the stretchable secondary battery 400, a rate determination characteristic of the stretchable secondary battery 400 may be improved, and long-term stability for charge/discharge cycles may be significantly improved. In addition, even when the stretchable secondary battery 400 is bent or stretched, performance of the stretchable secondary battery 400 may be maintained.

### Method for Manufacturing Stretchable Secondary Battery According to Modified Example of Present Invention

A method for manufacturing a stretchable secondary battery according to a modified example of the present invention is different from the method for manufacturing the stretchable secondary battery according to the embodiment of the present invention in that the stretchable coating layer is not formed on the surface of the negative electrode.

In addition, since the preparing of the curing composition, the preparing of the positive electrode and the negative electrode, and the forming of the stretchable coating layer by coating the positive electrode with the curable composition, evaporating the solvent, and irradiating the ultraviolet light in the method for manufacturing the stretchable coating layer according to an embodiment of the present invention have the same technical effects as the method for manufacturing the stretchable secondary battery according to the modified example of the present invention, descriptions thereof will be omitted, and the following description will be focused on preparing of the stretchable secondary battery by assembling the positive electrode and the negative electrode, which is different from the method for manufacturing the stretchable coating layer according to the embodiment of the present invention.

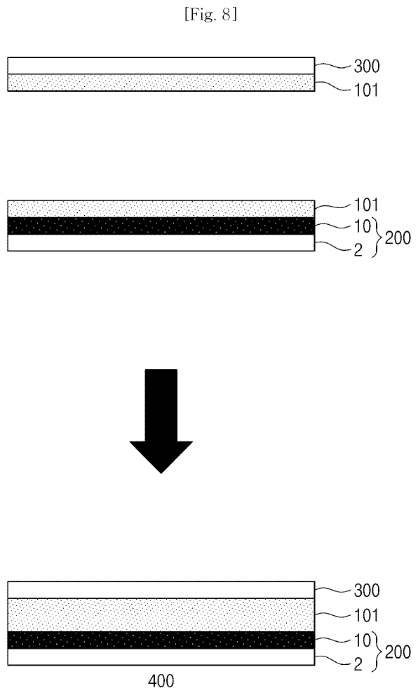

FIG. 8 is a view for describing a step of preparing a stretchable secondary battery by arranging a positive electrode and a negative electrode according to a modified example of the present invention.

Referring to FIG. 8, thermal curing may be performed while a stretchable coating layer 101 formed on a positive electrode 200 including a positive electrode current collector 2 and a positive electrode layer 10 and one surface of a negative electrode 300 are arranged to face each other so as to make contact with each other. In this case, the stretchable coating layer 101 may not be provided on the surface of the negative electrode 300. For example, a thermal curing condition may be controlled to be less than or equal to 130° C. Accordingly, the stretchable coating layer 101 formed on the positive electrode layer 10 of the positive electrode 200 and the one surface of the negative electrode 300 making contact with the stretchable coating layer 101 may be chemically bonded to each other.

Thereafter, the stretchable secondary battery 400 may be prepared by applying pressure that is lower than pressure applied when assembling a conventional secondary battery.

Therefore, according to the modified example of the present invention, unlike the embodiment of the present invention, the forming of the stretchable coating layer 101 by coating the negative electrode 300 with the curing composition 100, evaporating the solvent, and irradiating the curing composition 100 with the ultraviolet light may be omitted. Accordingly, a manufacturing process of the stretchable secondary battery 400 may be simplified. Accordingly, a manufacturing time of the stretchable secondary battery 400 may be shortened, and a manufacturing process cost may be reduced. As a result, mass production of the stretchable secondary battery 400 may be facilitated.

Hereinafter, specific experimental examples and characteristic evaluation results of the curable composition according to the embodiment of the present invention will be described.

### Curable Composition According to Experimental Example 1 (Solid Electrolyte Source)

A base solution (PVDF-HFP, 8 wt %) was prepared by dissolving a fluorine-based polymer (poly(vinylidene fluoride-co-hexafluoropropylene (PVDF-HFP), average Mw 400,000) in a solvent (dimethyl carbonate; DMC).

A curable composition was prepared by providing and dissolving lithium salt (lithium bis(trifluoromethanesulfonyl)imide (LiTFSI), 4 mol %), an ionic liquid (1-ethyl-3-methylimidazolium bis(trifluoromethylsulfonyl)imide (EMIMTFSI), 18.8 mol %), succinonitrile (69.2 mol %), an azide-based curing agent (2, 6-bis(4-azidobenzylidene)cyclohexanone, 0.05 mol %), and an additive (fluoroethylene carbonate, 5 vol %) in the base solution (a weight ratio of the ionic liquid and the succinonitrile in the curable composition was controlled to be 1:2).

### Curable Composition (Solid Electrolyte Source) According to Experimental Example 1-1

A curable composition according to Experimental Example 1-1 was prepared in the same manner as the curable composition according to Experimental Example 1, except that the ionic liquid and the succinonitrile were provided to the base solution such that the weight ratio of the ionic liquid and the succinonitrile is 1:3.

### Curable Composition (Solid Electrolyte Source) According to Experimental Example 1-2

A curable composition according to Experimental Example 1-2 was prepared in the same manner as the curable composition according to Experimental Example 1, except that the ionic liquid and the succinonitrile were provided to the base solution such that the weight ratio of the ionic liquid and the succinonitrile is 1:1.

### Curable Composition (Solid Electrolyte Source) According to Experimental Example 1-3

A curable composition according to Experimental Example 1-3 was prepared in the same manner as the curable composition according to Experimental Example 1, except that the ionic liquid and the succinonitrile were provided to the base solution such that the weight ratio of the ionic liquid and the succinonitrile is 2:1.

### Curable Composition (Solid Electrolyte Source) According to Experimental Example 2

A curable composition according to Experimental Example 2 was prepared in the same manner as the curable composition according to Experimental Example 1, except that the succinonitrile was not provided to the base solution.

### Curable Composition (Solid Electrolyte Source) According to Experimental Example 3

A curable composition according to Experimental Example 3 was prepared in the same manner as the curable composition according to Experimental Example 1, except that the ionic liquid was not provided to the base solution.

### Curable Composition (Solid Electrolyte Source) According to Experimental Example 4

A curable composition according to Experimental Example 4 was prepared in the same manner as the curable composition according to Experimental Example 1, except that acetone was used as the solvent instead of dimethyl carbonate.

### Curable Composition (Solid Electrolyte Source) According to Experimental Example 5

A curable composition according to Experimental Example 5 was prepared in the same manner as the curable composition according to Experimental Example 1, except that acetonitrile was used as the solvent instead of dimethyl carbonate.

TABLE 1

| | Classification | | | |
|---|---|---|---|---|
| | | | | Note |
| | | Ionic | | IL:SN |
| | | liquid | Succinonitrile | weight |
| | Solvent | (IL) | (SN) | ratio |
| Experimental | DMC | ◯ | ◯ | 1:2 |
| Example 1 | | | | |
| Experimental | DMC | ◯ | ◯ | 1:3 |
| Example 1-1 | | | | |
| Experimental | DMC | ◯ | ◯ | 1:1 |
| Example 1-2 | | | | |
| Experimental | DMC | ◯ | ◯ | 2:1 |
| Example 1-3 | | | | |
| Experimental | DMC | ◯ | X | 1:0 |
| Example 2 | | | | |
| Experimental | DMC | X | ◯ | 0:1 |
| Example 3 | | | | |
| Experimental | acetone | ◯ | ◯ | 1:2 |
| Example 4 | | | | |
| Experimental | acetonitrile | ◯ | ◯ | 1:2 |
| Example 5 | | | | |

### Positive Electrode According to Experimental Example 1

Positive electrode slurry was prepared by providing a positive electrode active material (LiFePO₄; LFP), a conductive material (single wall carbon nanotube; SWCNT), and a binder (polyvinylidene fluoride; PVDF) to a solvent (N-methyl-2-pyrrolidone; NMP) such that a weight ratio of the positive electrode active material, the conductive material, and the binder is 9:0.5:0.5 and performing mixing.

A positive electrode (positive electrode layer thickness 30 μm, loading amount 1.5 mg/cm²) was prepared by coating a positive electrode current collector (aluminum foil) with the positive electrode slurry by using a doctor blade, performing drying (vacuum, 60° C., 24 hours), and performing punching (diameter 16 mm).

### Positive Electrode According to Experimental Example 2

A positive electrode according to Experimental Example 2 was prepared in the same manner as the positive electrode according to Experimental Example 1, except that LiNi_{0.8}Co_{0.1}Mn_{0.1}O₂ (NCM) was used as the positive electrode active material instead of LiFePO₄ (LFP).

### Negative Electrode According to Experimental Example 1

Commercially available lithium foil (thickness 0.3 mm) was prepared as the negative electrode.

### Symmetric Cell According to Experimental Example 1

A symmetric cell was assembled by inserting a freestanding stretchable coating layer (solid electrolyte layer), which is formed by evaporating the solvent of the curable composition (solid electrolyte source) according to Experimental Example 1 and performing curing with ultraviolet light (365 nm, 0.7 W/cm², 60 seconds), between a pair of negative electrodes according to Experimental Example 1 and applying pressure.

### Symmetric Cell According to Experimental Example 2

A stretchable coating layer (solid electrolyte layer) was formed by coating the negative electrode according to Experimental Example 1 with the curable composition (solid electrolyte source) according to Experimental Example 1, evaporating the solvent, and performing curing with ultraviolet light (365 nm, 0.7 W/cm², 60 seconds). In the same manner, the stretchable coating layer (solid electrolyte layer) was formed on the negative electrode according to Experimental Example 1, and a symmetric cell was assembled by arranging the stretchable coating layers (solid electrolyte layers) to face each other so as to make contact with each other and applying pressure.

### Symmetric Cell According to Experimental Example 3

A symmetric cell according to Experimental Example 3 was assembled in the same manner as the symmetric cell according to Experimental Example 2, except that the curable composition (solid electrolyte source) according to Experimental Example 4 was used instead of the curable composition (solid electrolyte source) according to Experimental Example 1.

### Symmetric Cell According to Experimental Example 4

A symmetric cell according to Experimental Example 4 was assembled in the same manner as the symmetric cell according to Experimental Example 2, except that the curable composition (solid electrolyte source) according to Experimental Example 5 was used instead of the curable composition (solid electrolyte source) according to Experimental Example 1.

### Symmetric Cell According to Experimental Example 5

A symmetric cell according to Experimental Example 5 was assembled in the same manner as the symmetric cell according to Experimental Example 2, except that the curable composition (solid electrolyte source) according to Experimental Example 2 was used instead of the curable composition (solid electrolyte source) according to Experimental Example 1.

### Symmetric Cell According to Experimental Example 6

A symmetric cell according to Experimental Example 6 was assembled in the same manner as the symmetric cell according to Experimental Example 2, except that the curable composition (solid electrolyte source) according to Experimental Example 3 was used instead of the curable composition (solid electrolyte source) according to Experimental Example 1.

### Symmetric Cell According to Experimental Example 7

A symmetric cell according to Experimental Example 7 was assembled in the same manner as the symmetric cell according to Experimental Example 1, except that a separator (porous polypropylene film) soaked in a liquid electrolyte (1.0 M LiPF₆ in EC/DEC 1:1 vol %, with 7.5% FEC (4-fluoro-1,3-dioxolan-2-one)) was provided instead of the freestanding stretchable coating layer (solid electrolyte layer) prepared by using the curable composition (solid electrolyte source) according to Experimental Example 1.

### Coin Cell According to Experimental Example 1

A stretchable coating layer (solid electrolyte layer) was formed by coating the positive electrode according to Experimental Example 1 and the negative electrode according to Experimental Example 1 with the curing composition (solid electrolyte source) according to Experimental Example 1 by using a doctor blade (gap 100 μm), evaporating the solvent, and performing curing with ultraviolet light (365 nm, 0.7 W/cm², 60 seconds).

In addition, a CR2032-type coin cell was prepared by arranging the stretchable coating layer (solid electrolyte layer) formed on the positive electrode and the stretchable coating layer (solid electrolyte layer) formed on the negative electrode to face each other so as to make contact each other and applying pressure.

### Coin Cell According to Experimental Example 2

A CR2032-type coin cell was prepared by inserting a freestanding stretchable coating layer (solid electrolyte layer), which is prepared by evaporating the solvent of the curing composition (solid electrolyte source) according to Experimental Example 1 and performing curing with ultraviolet light (365 nm, 0.7 W/cm², 60 seconds), between the positive electrode according to Experimental Example 1 and the negative electrode according to Experimental Example 1 and applying pressure.

### Coin Cell According to Experimental Example 3

A coin cell according to Experimental Example 3 was prepared in the same manner as the coin cell according to Experimental Example 1, except that the curing composition (solid electrolyte source) according to Experimental Example 2 was used instead of the curing composition (solid electrolyte source) according to Experimental Example 1.

### Coin Cell According to Experimental Example 4

A coin cell according to Experimental Example 4 was prepared in the same manner as the coin cell according to Experimental Example 1, except that the positive electrode according to Experimental Example 2 was used instead of the positive electrode according to Experimental Example 1.

### Coin Cell According to Experimental Example 5

A coin cell according to Experimental Example 5 was prepared in the same manner as the coin cell according to Experimental Example 1, except that the curing composition (solid electrolyte source) according to Experimental Example 3 was used instead of the curing composition (solid electrolyte source) according to Experimental Example 1.

### Pouch Cell According to Experimental Example 1

A positive electrode was prepared by coating a positive electrode current collector (aluminum foil) with the positive electrode slurry (LFP, SWCNT, PVDF, NMP) according to Experimental Example 1 by using a doctor blade, performing drying (vacuum, 60° C., 24 hours), performing cutting (4 cm×3 cm), and attaching an aluminum tab.

In addition, a negative electrode was prepared by cutting (4.2 cm×3.2 cm) the negative electrode according to Experimental Example 1 and attaching a nickel tab.

In addition, a stretchable coating layer (solid electrolyte layer) was formed by coating the positive electrode and the negative electrode with the curing composition (solid electrolyte source) according to Experimental Example 1 by using a doctor blade (gap 100 μm), evaporating the solvent, and performing curing with ultraviolet light (365 nm, 0.7 W/cm², 60 seconds).

In addition, a pouch cell was prepared by arranging and assembling the stretchable coating layer (solid electrolyte layer) formed on the positive electrode and the stretchable coating layer (solid electrolyte layer) formed on the negative electrode to face each other so as to make contact with each other, covering with a pouch film, and sealing with a heat sealer.

### Pouch Cell According to Experimental Example 2

A pouch cell according to Experimental Example 2 was prepared in the same manner as the pouch cell according to Experimental Example 1, except that LiNi_{0.8}Co_{0.1}Mn_{0.1}O₂ (NCM) was used as the positive electrode active material in the positive electrode slurry according to Experimental Example 1 instead of LiFePO₄ (LFP).

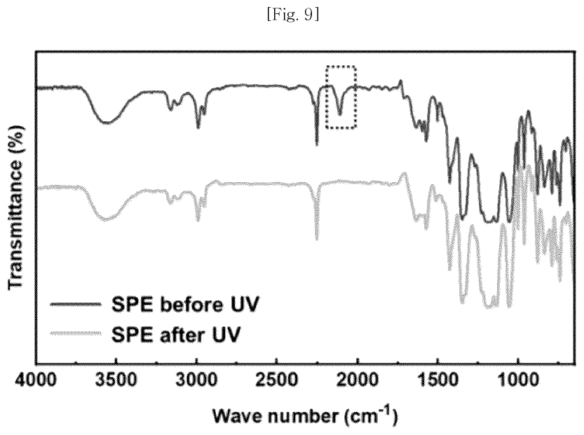

FIG. 9 shows FT-IR analysis results before/after ultraviolet light irradiation of a solid electrolyte source according to Experimental Example 1 of the present invention.

Referring to FIG. 9, FT-IR analysis was performed in a state where a glass substrate is coated with the solid electrolyte source according to Experimental Example 1, and the solvent is evaporated, and FT-IR analysis was performed in a state where the glass substrate is coated with the solid electrolyte source according to Experimental Example 1, the solvent is evaporated, and irradiation with ultraviolet light (365 nm, 0.7 Wcm⁻², 60 seconds) is performed.

As shown in FIG. 9, it may be found that when the solid electrolyte source according to Experimental Example 1 is irradiated with the ultraviolet light, a peak corresponding to an azide (N₃) observed at 2,110 cm⁻¹ completely disappeared.

Therefore, it may be found that the azide (N₃) of the azide-based curing agent in the solid electrolyte source according to Experimental Example 1 was converted into a nitrene intermediate by the ultraviolet light, and provided to a C—H bond chain of the fluorine-based polymer, the succinonitrile, the ionic liquid (EMIM⁺), and the additive so as to form a secondary amine bond.

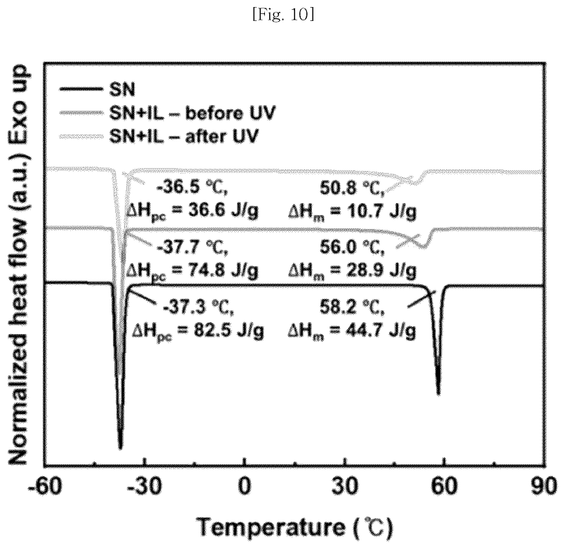

FIG. 10 shows differential scanning calorimetry (DSC) analysis results for succinonitrile and a mixture according to an experimental example of the present invention.

Referring to FIG. 10, pure succinonitrile SN was analyzed by DSC, a mixture SN+IL of the succinonitrile SN, the ionic liquid IL, and the azide-based curing agent was analyzed by DSC, and the mixture SN+IL was irradiated with ultraviolet light (365 nm, 0.7 Wcm⁻², 60 seconds) and analyzed by DSC. In detail, the DSC analysis was performed by sweeping a temperature from −70° C. to 100° C. and from −50° C. to 200° C. at a speed of 5° C./min under nitrogen gas, and masses of the succinonitrile SN and the mixture SN+IL were controlled to be 5 mg to 10 mg.

As shown in FIG. 10, it may be found that a melting point Tₘ of the pure succinonitrile was 58.2° C., and a plastic crystal phase transition temperature T_{PC} was −37.3° C.

In addition, it may be found that compared to the pure succinonitrile, the melting point Tₘ of the mixture was slightly reduced to 56.0° C., and melting enthalpy ΔHₘ was significantly reduced from 44.7 J/g to 28.9 J/g, while the plastic crystal phase transition temperature T_{PC} and plastic crystal phase transition enthalpy ΔH_{PC} were substantially at the same levels. Accordingly, it may be found that although physical mixing of the succinonitrile and the ionic liquid interferes with plastic crystal formation of the succinonitrile, the physical mixing does not substantially affect actual crystal formation.

In addition, it may be found that when the mixture is irradiated with ultraviolet light, the melting point Tₘ was reduced to 50.8° C., the melting enthalpy ΔHₘ was reduced to 10.7 J/g, and the plastic crystal phase transition enthalpy ΔH_{PC} was reduced by half or more from 74.8 J/g to 36.6 J/. Accordingly, it may be found that the succinonitrile and the azide-based curing agent were crosslinked, so that both plastic crystallinity and actual crystallinity of the succinonitrile were reduced.

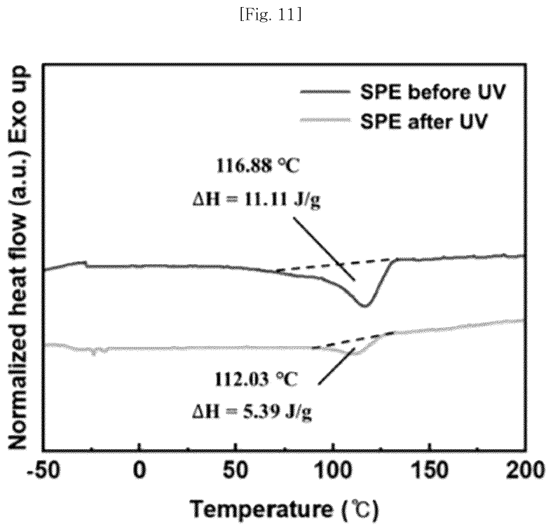

FIG. 11 shows differential scanning calorimetry (DSC) analysis results before/after the ultraviolet light irradiation of the solid electrolyte source according to Experimental Example 1 of the present invention.

Referring to FIG. 11, DSC analysis was performed in a state where the solvent in the solid electrolyte source according to Experimental Example 1 is evaporated (SPE before UV), and DSC analysis was performed in a state where the solvent the solid electrolyte source according to Experimental Example 1 is evaporated, and irradiation with ultraviolet light (365 nm, 0.7 Wcm⁻², 60 seconds) is performed (SPE after UV). In detail, the DSC analysis was performed by sweeping a temperature from −70° C. to 100° C. and from −50° C. to 200° C. at a speed of 5° C./min under nitrogen gas, and a mass of the solid electrolyte source according to Experimental Example 1 was controlled to be 5 mg to 10 mg.

As shown in FIG. 11, it may be found that a melting point Tₘ of a PVDF crystal in the solid electrolyte source according to Experimental Example 1 before the irradiation with the ultraviolet light was 116.88° C., and a crystal peak for succinonitrile was not observed.

It may be found that after the irradiation with the ultraviolet light, the melting point Tₘ of the PVDF crystal in the solid electrolyte layer according to Experimental Example 1 was reduced to 112.03° C., and the melting enthalpy ΔHₘ was significantly reduced from 11.11 J/g to 5.39 J/g. Therefore, it may be found that when the solid electrolyte source according to Experimental Example 1 is irradiated with the ultraviolet light, crystallinity of PVDF was significantly reduced. The factor of the above configuration may be interpreted to be due to the fact that the azide (N₃) of the azide-based curing agent in the solid electrolyte source according to Experimental Example 1 was converted into a nitrene intermediate by the ultraviolet light, and provided to a C—H bond chain of the fluorine-based polymer, the succinonitrile, the ionic liquid (EMIM⁺), and the additive so as to form a secondary amine bond having a three-dimensional network structure, so that the crystallinity of the PVDF was reduced, and thus an amorphous phase was increased.

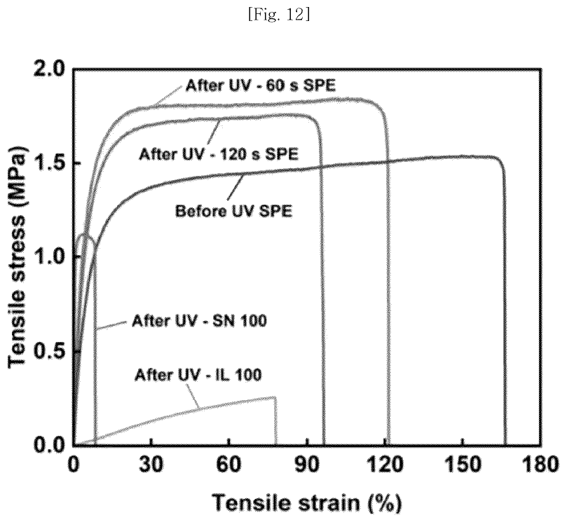

FIG. 12 shows stress-strain curves of solid electrolyte layers according to experimental examples of the present invention.

Referring to FIG. 12, a freestanding first solid electrolyte layer (Before UV SPE; thickness 200 μm, size 3.0 cm×1.5 cm) was prepared by coating a glass substrate with the solid electrolyte source according to Experimental Example 1 and evaporating the solvent; a freestanding second solid electrolyte layer (After UV-60 s SPE; thickness 200 μm, size 3.0 cm×1.5 cm) was prepared by coating the glass substrate with the solid electrolyte source according to Experimental Example 1, evaporating the solvent, and performing irradiation with ultraviolet light (365 nm, 0.7 Wcm⁻², 60 seconds); a freestanding third solid electrolyte layer (After UV-120 s SPE; thickness 200 μm, size 3.0 cm×1.5 cm) was prepared by coating the glass substrate with the solid electrolyte source according to Experimental Example 1, evaporating the solvent, and performing irradiation with ultraviolet light (365 nm, 0.7 Wcm⁻², 120 seconds); a freestanding fourth solid electrolyte layer (After UV-IL 100; thickness 200 μm, size 3.0 cm×1.5 cm) was prepared by coating the glass substrate with the solid electrolyte source according to Experimental Example 2, evaporating the solvent, and performing irradiation with ultraviolet light (365 nm, 0.7 Wcm², 60 seconds); and a freestanding fifth solid electrolyte layer (After UV-SN 100; thickness 200 μm, size 3.0 cm×1.5 cm) was prepared by coating the glass substrate with the solid electrolyte source according to Experimental Example 3, evaporating the solvent, and performing irradiation with ultraviolet light (365 nm, 0.7 Wcm⁻², 60 seconds). In addition, the freestanding first to fifth solid electrolyte layers were provided to a tension tester (Universal Testing Systems, UTM) to measure strain according to stress (speed 30 mm/min).

As shown in FIG. 12, it may be found that a Young's modulus of the first solid electrolyte layer was 7.7 MPa, and maximum strain of 160% was obtained. In comparison, it may be found that a Young's modulus of the second solid electrolyte layer was increased to 10.2 MPa. The factor of the above configuration may be interpreted to be due to the fact that when the solid electrolyte source according to Experimental Example 1 is irradiated with the ultraviolet light, a three-dimensional network structure was formed by the azide-based curing agent, so that mechanical properties were improved.

In addition, it may be found that a Young's modulus of the third solid electrolyte layer was lower than the Young's modulus of the second solid electrolyte layer.

In addition, it may be found that a Young's modulus of the fourth solid electrolyte layer and a Young's modulus of the fifth solid electrolyte layer were excessively high or low.

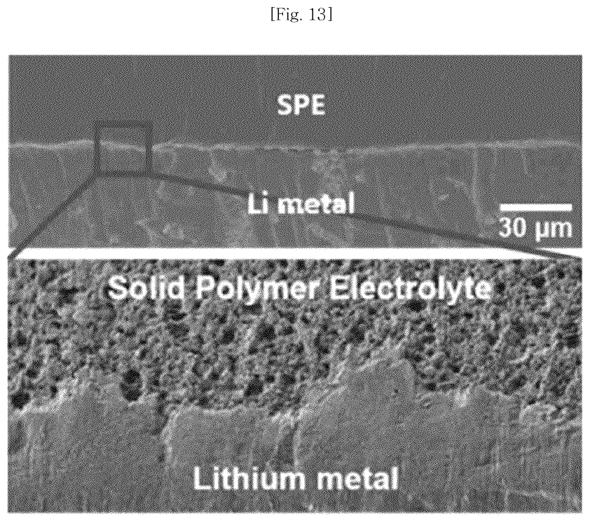

FIG. 13 shows a SEM photograph of a solid electrolyte layer on a negative electrode in a coin cell according to Experimental Example 1 of the present invention.

Referring to FIG. 13, the negative electrode according to Experimental Example 1 and the solid electrolyte layer formed on the negative electrode were separated from the coin cell according to Experimental Example 1, cutting was performed with an ion beam, and a section was photographed by an SEM.

As shown in FIG. 13, it may be found that the solid electrolyte layer substantially made close contact with the negative electrode according to Experimental Example 1. Accordingly, it may be found that since the solid electrolyte source according to Experimental Example 1 has sufficient wettability for an electrode surface in a liquid state, the electrode surface was conformally coated with the solid electrolyte source according to Experimental Example 1, and a state in which the solid electrolyte source according to Experimental Example 1 makes close contact with the surface of the electrode was maintained even after the evaporation of the solvent and the curing with the ultraviolet light.

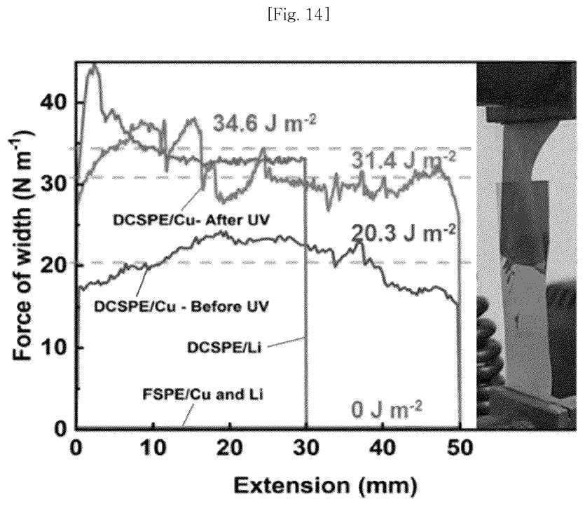

FIG. 14 is a graph obtained by measuring adhesive strength of solid electrolyte layers according to experimental examples of the present invention.

Referring to FIG. 14, a first specimen (DCSPE/Cu-Before) was prepared by coating copper foil with the solid electrolyte source according to Experimental Example 1, and evaporating the solvent so as to form a solid electrolyte layer; a second specimen (DCSPE/Cu-After UV) was prepared by coating the copper foil with the solid electrolyte source according to Experimental Example 1, evaporating the solvent, and performing irradiation with ultraviolet light (365 nm, 0.7 Wcm², 60 seconds) so as to form a solid electrolyte layer; a third specimen (FSPE/Cu) was prepared by preparing a freestanding solid electrolyte layer by using the solid electrolyte source according to Experimental Example 1 and compressing the solid electrolyte layer with the copper foil; a fourth specimen (FSPE/Li) was prepared by preparing a freestanding solid electrolyte layer by using the solid electrolyte source according to Experimental Example 1 and compressing the solid electrolyte layer with lithium foil; and a fifth specimen (DCSPE/Li) was prepared by coating the lithium foil with the solid electrolyte source according to Experimental Example 1, evaporating the solvent, and performing irradiation with ultraviolet light (365 nm, 0.7 Wcm⁻², 60 seconds) so as to form a solid electrolyte layer. In addition, the first to fifth specimens were provided to a universal testing machine so as to measure (100 mm/min, 180° peeling) adhesive strength between metal foil (copper foil or lithium foil) and the solid electrolyte layer.

As shown in FIG. 14, it may be found that adhesive strength of the fifth specimen was 34.6 J/m², which is the best. In addition, it may be found that adhesive strength of the second specimen (31.4 J/m²) was better than adhesive strength of the first specimen (20.3 J/m²).

In addition, as shown in a photograph inserted in FIG. 14, it may be found that a residue of the solid electrolyte layer existed on the copper foil after the measurement of the adhesive strength of the second specimen was completed. Accordingly, it may be found that the solid electrolyte source according to Experimental Example 1 had the adhesive strength with respect to the lithium foil and the copper foil, and the adhesive strength with respect to the lithium foil and adhesive strength with respect to the copper foil were improved upon the curing by the ultraviolet light.

In contrast, it may be found that the adhesive strength of the third specimen and the adhesive strength of the fourth specimen were 0 J/m². Accordingly, it may be found that the freestanding solid electrolyte layer formed by using the solid electrolyte source according to Experimental Example 1 has substantially no adhesive strength with respect to the lithium foil and the copper foil.

In summary, it may be found that when the lithium foil or the copper foil is directly coated with the solid electrolyte source according to Experimental Example 1, and the curing is performed by the ultraviolet light, the fluorine polymer, the positive ions of the ionic liquid, the succinonitrile, and the additive are crosslinked by the azide-based curing agent in the solid electrolyte source according to Experimental Example 1, and also chemically react with a surface of the lithium foil or the copper foil so as to be bonded thereto, so that the adhesive strength between the metal foil and the solid electrolyte layer may be improved.

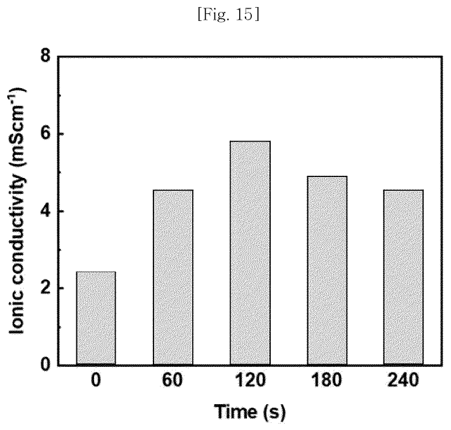

FIG. 15 is a graph for comparing ionic conductivity of a solid electrolyte layer according to a time of ultraviolet light with which the solid electrolyte source according to Experimental Example 1 of the present invention is irradiated.

Referring to FIG. 15, cells were prepared by arranging freestanding solid electrolyte layers, which are formed by evaporating the solvent in the solid electrolyte source according to Experimental Example 1 and controlling an irradiation time of the ultraviolet light (365 nm, 0.7 W/cm²) to be 0 second, 60 seconds, 120 seconds, 180 seconds, and 240 seconds, between a pair of stainless steel electrodes. In addition, bulk resistance R_{b} of the cell was measured by using electrochemical impedance spectroscopy so as to calculate ionic conductivity for the solid electrolyte layer at a room temperature by using [Mathematical Formula 1] below.

σ (ionic conductivity)=D (distance between stainless steel electrodes)/R_{b} (bulk resistance) S (contact area between solid electrolyte layer and stainless steel electrode) [Mathematical Formula 1]

As shown in FIG. 15, it may be found that when the irradiation of the ultraviolet light is not performed, ionic conductivity for the solid electrolyte layer at a room temperature was 2.7 mS/cm.

In addition, when the irradiation of the ultraviolet light is performed for 120 seconds, the ionic conductivity of the solid electrolyte layer at a room temperature was 5.4 mS/cm, which is the highest. The factor of the above configuration may be interpreted to be due to the fact that crystallinity of the fluorine-based polymer, the positive ions of the ionic liquid, the succinonitrile, and the additive was reduced due to the crosslinking by the azide-based curing agent, so that conduction of ions was promoted in the solid electrolyte layer.

In contrast, when the irradiation of the ultraviolet light is performed for more than 120 seconds (180 seconds, 240 seconds), the ionic conductivity was reduced due to excessive crosslinking by the azide-based curing agent.

Therefore, according to an embodiment of the present disclosure, it may be found that a scheme of controlling an irradiation time of ultraviolet light with which a curable composition (polymer electrolyte source) is irradiated to be greater than 60 seconds and less than 180 seconds is a scheme of optimizing a crosslinking level in a stretchable coating layer (solid electrolyte layer) so as to improve ionic conductivity of the stretchable coating layer (solid electrolyte layer).

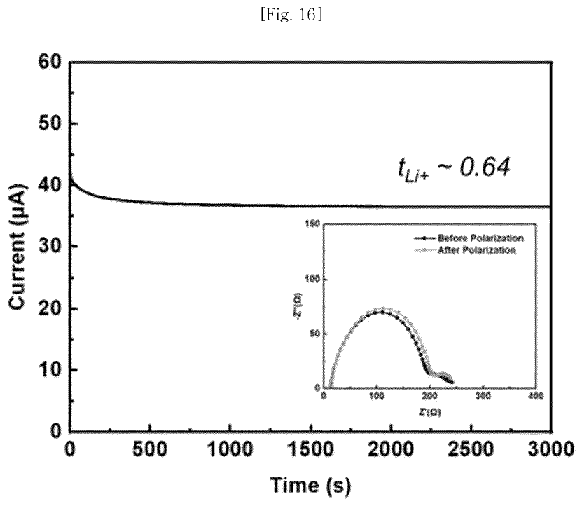

FIG. 16 is a graph showing a lithium ion transference number t_{Li+} for a freestanding solid electrolyte layer prepared by using the solid electrolyte source according to Experimental Example 1 of the present invention.

Referring to FIG. 16, a cell was prepared by arranging a freestanding solid electrolyte layer, which is obtained through curing by irradiation with ultraviolet light by using the solid electrolyte source according to Experimental Example 1, between a pair of stainless steel electrodes. In addition, a 10 mV potential ΔV was applied to the cell to collect current values of an initial state I₀ and a steady state I_{SS}, interfacial resistances of an initial state R₀ and a steady state R_{SS} were collected by electrochemical impedance spectroscopy, and a lithium ion transference number t_{Li+} of the solid electrolyte layer at 30° C. was calculated by using [Mathematical Formula 2] below.

$${t}_{Li +} = {I}_{SS} ( Δ V - {I}_{0} {R}_{0} ) / {I}_{0} ( Δ V - {I}_{SS} {R}_{SS} ) \qquad [ Mathematical Formula 2 ]$$

As shown in FIG. 16, it may be found that the lithium ion transference number of the solid electrolyte layer was 0.64. It may be found that the lithium ion transference number of the solid electrolyte layer had a significantly higher value than a conventional liquid electrolyte lithium ion transference number (0.2 to 0.4) and a conventional solid electrolyte lithium ion transference number (0.4 to 0.5).

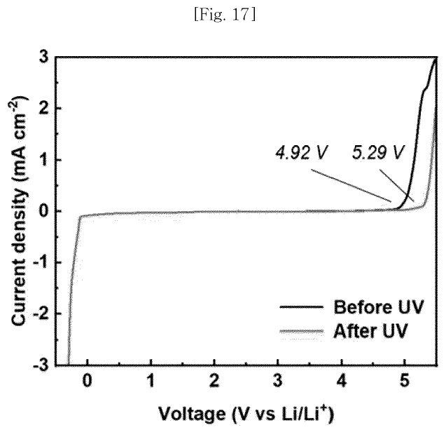

FIG. 17 is a graph for comparing electrochemical properties before/after the ultraviolet light irradiation of the solid electrolyte source according to Experimental Example 1 of the present invention.

Referring to FIG. 17, a first solid electrolyte layer was formed by evaporating the solvent in the solid electrolyte source according to Experimental Example 1, and a cell was prepared by arranging the first solid electrolyte layer between a stainless steel disk and a lithium metal. In addition, an initiation voltage was measured by scanning the cell at a speed of 1.0 mV/s from −1 V to 6 V (Li/Li⁺). In addition, a second solid electrolyte layer was formed by evaporating the solvent in the solid electrolyte source according to Experimental Example 1 and performing irradiation with ultraviolet light, and a cell was prepared by arranging the second solid electrolyte layer between the stainless steel disk and the lithium metal. In addition, an initiation voltage was measured by scanning the cell at a speed of 1.0 mV/s from −1 V to 6 V (Li/Li⁺).

As shown in FIG. 17, it may be found that the initiation voltage of the first solid electrolyte layer is 4.92 V, but the initiation voltage of the second solid electrolyte layer, which is cured by irradiating with ultraviolet light, increases to 5.29 V. The factor of the above configuration may be interpreted to be due to the fact that reactive parts were consumed by the crosslinking that occurs in the solid electrolyte source during an ultraviolet light irradiation process so that electrochemical stability was improved.

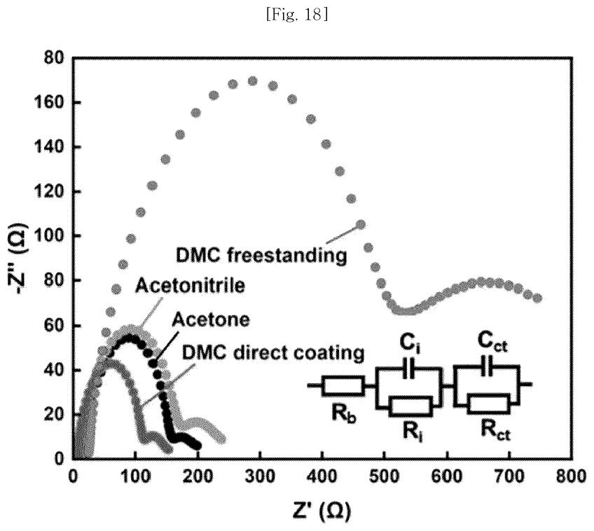

FIG. 18 is a graph for comparing bulk resistance R_{b} and interfacial resistance Ri of symmetric cells according to experimental examples of the present invention.

Referring to FIG. 18, bulk resistance R_{b} and interfacial resistance Rᵢ of a symmetric cell according to Experimental Example 1 (DMC freestanding), a symmetric cell according to Experimental Example 2 (DMC direct coating), a symmetric cell according to Experimental Example 3 (Acetone), and a symmetric cell according to Experimental Example 4 (Acetonitrile) were measured by using electrochemical impedance spectroscopy.

As shown in FIG. 18, it may be found that the symmetric cell according to Experimental Example 1 had bulk resistance R_{b} of 25Ω and interfacial resistance Rᵢ of 540Ω. In addition, it may be found that the symmetric cell according to Experimental Example 2 had bulk resistance R_{b} of 7Ω and interfacial resistance Rᵢ of 113Ω. In addition, it may be found that the symmetric cell according to Experimental Example 3 had bulk resistance R_{b} of 18Ω and interfacial resistance Rᵢ of 157Ω. In addition, it may be found that the symmetric cell according to Experimental Example 4 had bulk resistance R_{b} of 11Ω and interfacial resistance Rᵢ of 176Ω.

Therefore, it may be found that the bulk resistance and interfacial resistance of the symmetric cell according to Experimental Example 2 were the lowest.

Accordingly, in the method for manufacturing the curable composition (solid electrolyte source) according to the embodiment of the present disclosure, it may be found that a scheme of using dimethyl carbonate (DMC) as a solvent is a scheme of reducing resistance of a stretchable coating layer (solid electrolyte layer). In addition, it may be found that a scheme of forming the stretchable coating layer (solid electrolyte layer) by directly coating a negative electrode with the curable composition (solid electrolyte source) and performing curing with ultraviolet light is a scheme of further reducing the resistance as compared to a scheme of compressing a freestanding stretchable coating layer (solid electrolyte layer) on the negative electrode.

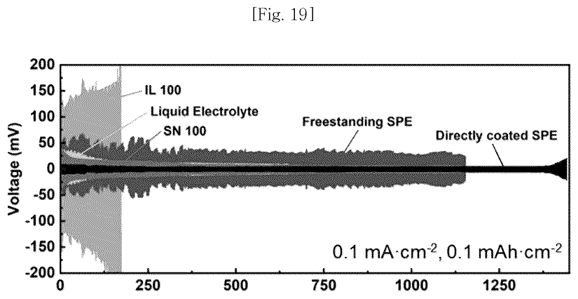

FIG. 19 is a graph for comparing performance of symmetric cells according to experimental examples of the present invention.

Referring to FIG. 19, a voltage according to a time was measured for a symmetric cell according to Experimental Example 5 (IL 100), a symmetric cell according to Experimental Example 6 (SN 100), a symmetric cell according to Experimental Example 7 (Liquid Electrolyte), a symmetric cell according to Experimental Example 1 (Freestanding SPE), and a symmetric cell according to Experimental Example 2 (Directly coated SPE) at current density of 0.1 mA/cm² and a capacity of 0.1 mAh/cm².

As shown in FIG. 19, it may be found that the symmetric cells according to Experimental Example 7 and Experimental Example 1 initially exhibited an arch-shaped voltage profile, and had a short circuit after 640 hours and 1,150 hours, respectively.

In addition, it may be found that the symmetric cell according to Experimental Example 5 had a relatively high overvoltage and a short cycle lifespan due to low mechanical strength.

In addition, it may be found that the symmetric cell according to Experimental Example 6 had an increased overvoltage and an arch-shaped voltage profile due to side reaction between the succinonitrile and the negative electrode (lithium foil) in the solid electrolyte layer.

Meanwhile, it may be found that the symmetric cell according to Experimental Example 2 exhibited stable performance by maintaining a flat voltage profile with a low overvoltage of 5 mV for 1,400 hours or more. The factor of the above configuration may be interpreted to be due to the fact that due to the solid electrolyte layer in the symmetric cell according to Experimental Example 2, ionic conductivity, stretchability, mechanical properties, and adhesive strength were improved, and uniform lithium ion flux was provided.

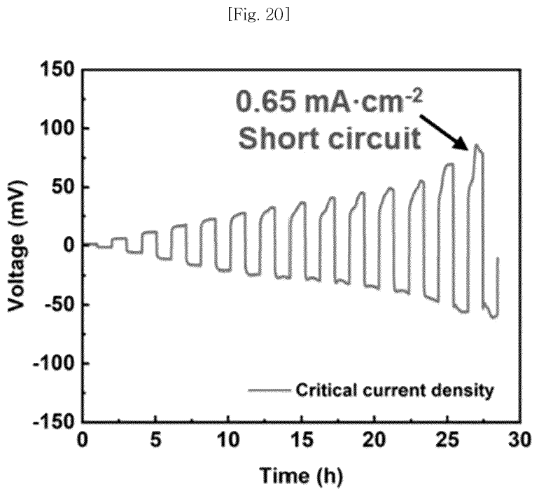

FIG. 20 is a graph obtained by measuring critical current density of a symmetric cell according to Experimental Example 2 of the present invention.

Referring to FIG. 20, current density at which a short circuit occurs was measured while increasing the current density by 0.05 mA/cm² in the symmetric cell according to Experimental Example 2.

As shown in FIG. 20, it may be found that critical current density at which a short circuit occurs in the symmetric cell according to Experimental Example 2 was 0.65 mA/cm².

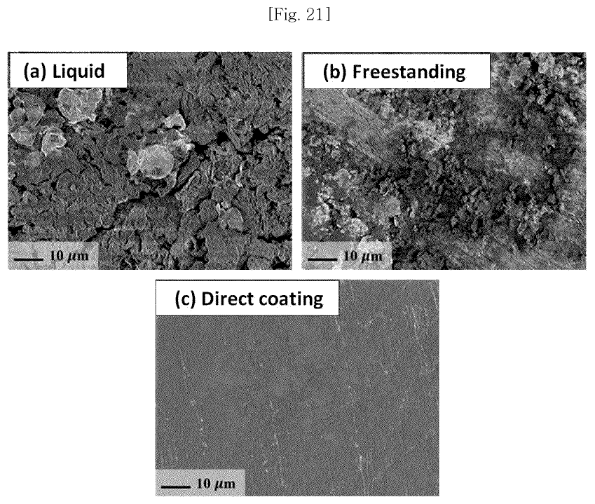

FIG. 21 shows SEM photographs of solid electrolyte layers after charge/discharge cycles of symmetric cells according to experimental examples of the present invention.

Referring to (a) to (c) of FIG. 21, a symmetric cell according to Experimental Example 7 (Liquid), a symmetric cell according to Experimental Example 1 (Freestanding), and a symmetric cell according to Experimental Example 2 (Direct coating) were subjected to 100 charge/discharge cycles (0.1 mA/cm², 0.1 mAh/cm²), the symmetric cells were disassembled, and a surface of the solid electrolyte layer formed on the lithium foil was photographed by an SEM.

As shown in (a) to (c) of FIG. 21, it may be found that dendrite was formed in a mossy structure on the surface of the solid electrolyte layer of the symmetric cell according to Experimental Example 7.

In comparison, it may be found that the symmetric cell according to Experimental Example 1 had a less amount of dendrite formed on the surface of the solid electrolyte layer as compared to the symmetric cell according to Experimental Example 7.

In addition, it may be found that the surface of the solid electrolyte layer of the symmetric cell according to Experimental Example 2 had the smoothest surface without a mossy structure or stripes being observed. In other words, it may be found that the dendrite was not formed substantially.

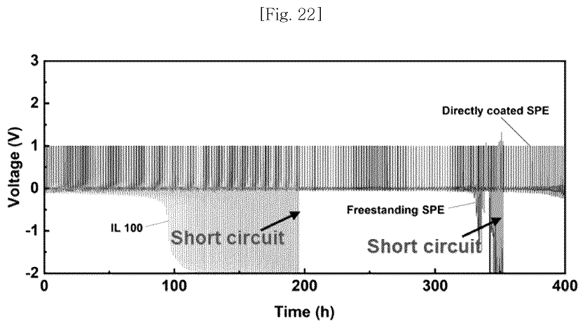

FIG. 22 is a graph for comparing performance of coin cells according to Experimental Examples 1 to 3 of the present invention.

Referring to FIG. 22, a voltage according to a time was measured for the coin cells according to Experimental Examples 1 to 3 at current density of 0.1 mA/cm² and a capacity of 0.1 mAh/cm².

As shown in FIG. 22, it may be found that the coin cell according to Experimental Example 1 operated stably with a low overvoltage of 25 mV for 400 hours or more (200 charge/discharge cycles or more).

In addition, it may be found that the coin cell according to Experimental Example 2 had a short circuit before 350 hours.

In addition, it may be found that the coin cell according to Experimental Example 3 had a short circuit before 200 hours due to low mechanical strength of the solid electrolyte layer.

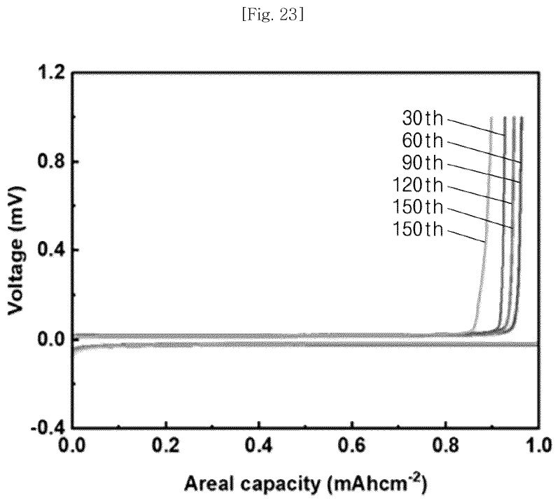

FIG. 23 is a graph showing a voltage profile according to charge/discharge cycles of the coin cell according to Experimental Example 1 of the present invention.

Referring to FIG. 23, a voltage profile for 180 charge/discharge cycles (0.1 mA/cm², 0.1 mAh/cm²) of the coin cell according to Experimental Example 1 was shown in a graph.

As shown in FIG. 23, it may be found that the coin cell according to Experimental Example 1 stably and reversibly charged (Li plating)/discharged (Li stripping) for 180 times or more due to the solid electrolyte layer.

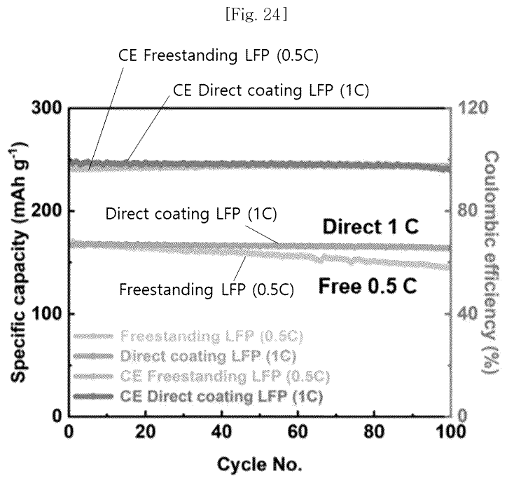

FIG. 24 is a graph for comparing charge/discharge cycle performance of the coin cells according to Experimental Examples 1 and 2 of the present invention.

Referring to FIG. 24, a discharge capacity and a capacity retention rate were measured while performing 100 charge/discharge cycles (2.0 to 3.8 V, 1 C) of the coin cell according to Experimental Example 1, and a discharge capacity and a capacity retention rate were measured while performing 100 charge/discharge cycles (2.0 to 3.8 V, 0.5 C) of the coin cell according to Experimental Example 2.

As shown in FIG. 24, it may be found that the coin cell according to Experimental Example 1 maintained a higher discharge capacity (165 mAh/g) than the coin cell according to Experimental Example 2.

In addition, it may be found that the capacity retention rates of the coin cell according to Experimental Example 1 and the coin cell according to Experimental Example 2 were at similar levels.

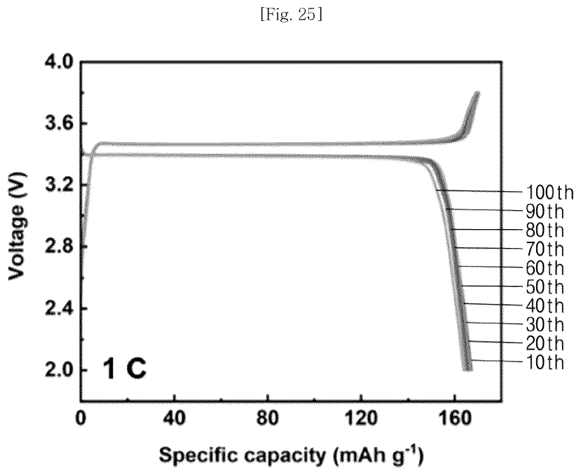

FIG. 25 is a graph showing a voltage profile according to charge/discharge cycles of the coin cell according to Experimental Example 1 of the present invention.

Referring to FIG. 25, a voltage profile for 100 charge/discharge cycles (2.0 to 3.8V, 1C) of the coin cell according to Experimental Example 1 was shown in a graph.

As shown in FIG. 25, it may be found that the voltage profile of the coin cell according to Experimental Example 1 was consistently maintained during the 100 charge/discharge cycles, and exhibited a low overvoltage (70 mV) and a stable plateau. The factor of the above configuration may be interpreted to be due to the fact that due to the solid electrolyte layer in the coin cell according to Experimental Example 1, ionic conductivity, stretchability, mechanical properties, and adhesive strength were improved, and uniform lithium ion flux was formed.

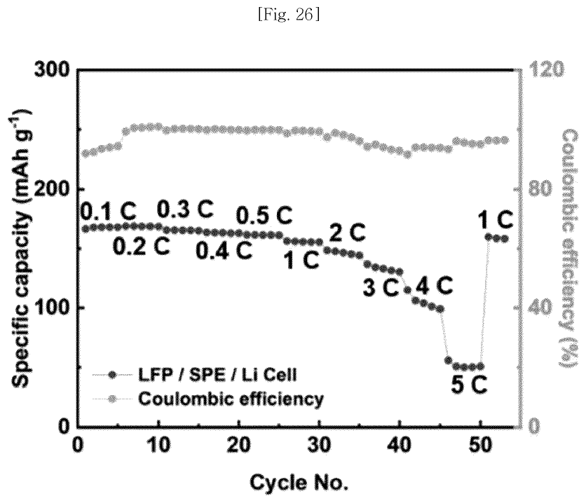

FIG. 26 is a graph showing a rate determination characteristic of the coin cell according to Experimental Example 1 of the present invention.

Referring to FIG. 26, a capacity of the coin cell according to Experimental Example 1 was measured as 5 charge/discharge cycles (2.0 to 3.8 V) are performed at each C-rate while increasing into 0.1 C→0.5 C→1 C→2 C→3 C→4 C→5 C.

As shown in FIG. 26, it may be found that the coin cell according to Experimental Example 1 had a discharge capacity of 130 mAh/g at 3 C, and 99 mAh/g at 4 C. It may be found that these correspond to 79% and 60% of a 0.1 C capacity, respectively, and an excellent rate determination characteristic was obtained as compared to a conventional solid electrolyte layer.

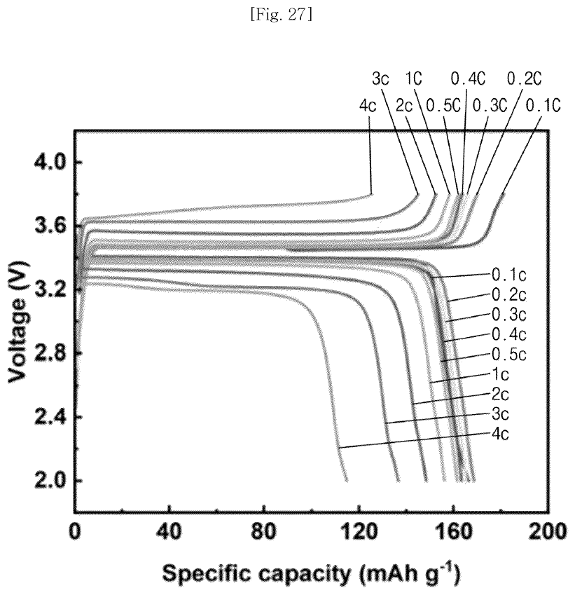

FIG. 27 is a graph showing a voltage profile according to rate determination of the coin cell according to Experimental Example 1 of the present invention.

Referring to FIG. 27, a voltage profile for charge/discharge cycles (2.0 to 3.8 V) of the coin cell according to Experimental Example 1 for each C-rate (0.1 C→0.5 C→1 C→2 C→3 C 4 C→5 C) was shown in a graph.

As shown in FIG. 27, it may be found that the coin cell according to Experimental Example 1 maintained a stable plateau at each rate determination, and operated stably without a significant capacity loss even at relatively high rate determination (3 C, 4 C).

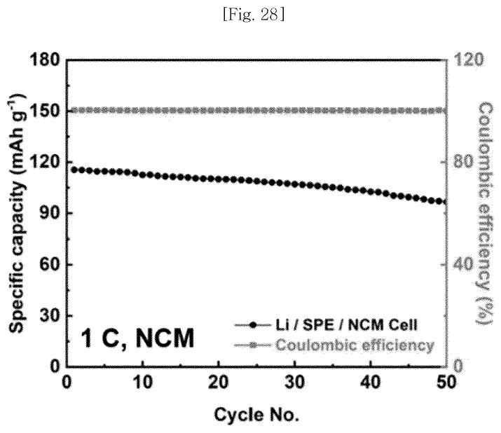

FIG. 28 is a graph for describing charge/discharge cycle performance of a coin cell according to Experimental Example 4 of the present invention.

Referring to FIG. 28, a capacity of the coin cell according to Experimental Example 4 was measured as 50 charge/discharge cycles (1 C) are performed.

As shown in FIG. 28, it may be found that the coin cell according to Experimental Example 4 maintained a capacity of 100 mAh/g or more even after 50 charge/discharge cycles.

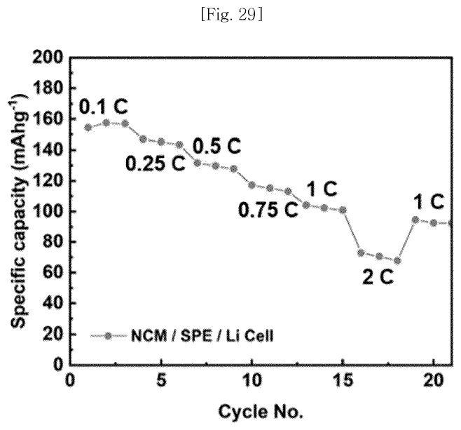

FIG. 29 is a graph for describing a rate determination characteristic of the coin cell according to Experimental Example 4 of the present invention.

Referring to FIG. 29, a capacity of the coin cell according to Experimental Example 4 was measured as 3 charge/discharge cycles are performed at each C-rate while changing the C-rate into 0.1 C→0.25 C→0.5 C→0.75 C→1 C→2 C→1 C.

As shown in FIG. 29, it may be found that a rate determination characteristic of the coin cell according to Experimental Example 4 was excellent.

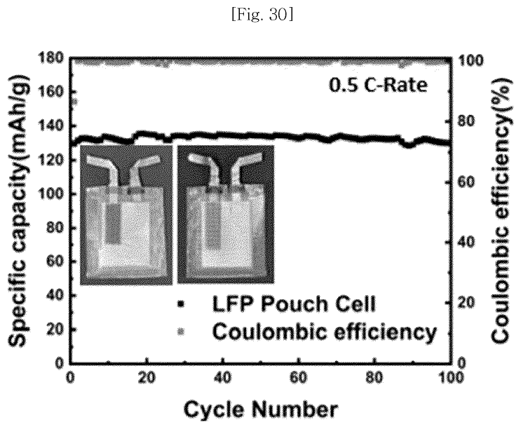

FIG. 30 is a graph for describing charge/discharge cycle performance of a pouch cell according to Experimental Example 1 of the present invention.

Referring to FIG. 30, a capacity of the pouch cell according to Experimental Example 1 was measured while performing 100 charge/discharge cycles (0.5 C).

As shown in FIG. 30, it may be found that the pouch cell according to Experimental Example 1 stably maintained a capacity of 130 mAh/g during the 100 charge/discharge cycles.

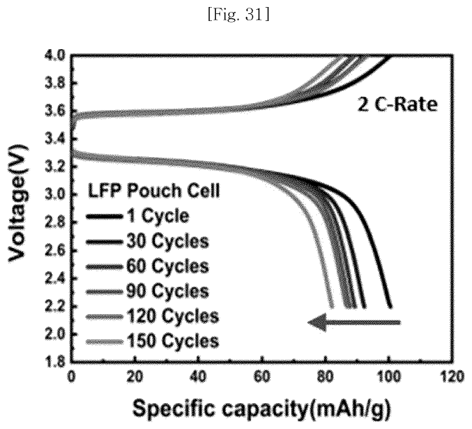

FIG. 31 is a graph showing a voltage profile for charge/discharge cycles of the pouch cell according to Experimental Example 1 of the present invention.

Referring to FIG. 31, a voltage profile for 150 charge/discharge cycles (2 C) of the pouch cell according to Experimental Example 1 was shown in a graph.

As shown in FIG. 31, it may be found that the pouch cell according to Experimental Example 1 maintained a stable voltage profile during the 150 charge/discharge cycles.

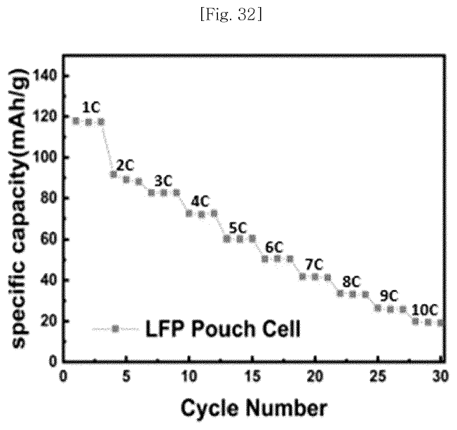

FIG. 32 is a graph for describing a rate determination characteristic of the pouch cell according to Experimental Example 1 of the present invention.

Referring to FIG. 32, a capacity of the pouch cell according to Experimental Example 1 was measured as 3 charge/discharge cycles are performed at each C-rate while changing the C-rate from 1 C to 10 C.

As shown in FIG. 32, it may be found that the pouch cell according to Experimental Example 1 may efficiently perform lithium ion transference even at high-rate-determination charging/discharging due to the solid electrolyte layer having high ionic conductivity.

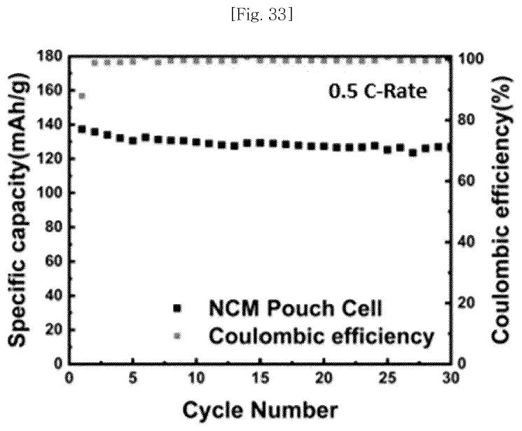

FIG. 33 is a graph for describing charge/discharge cycle performance of a pouch cell according to Experimental Example 2 of the present invention.

Referring to FIG. 33, a capacity was measured while performing 30 charge/discharge cycles (0.5 C) of the pouch cell according to Experimental Example 2.

As shown in FIG. 33, it may be found that the pouch cell according to Experimental Example 2 exhibited a capacity retention rate of 92.1% and coulombic efficiency of 99.2%.

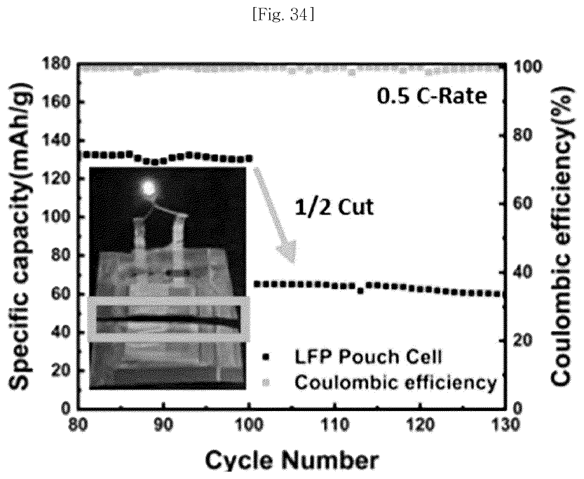

FIG. 34 is a graph for describing battery performance after cutting the pouch cell according to Experimental Example 1 of the present invention.

Referring to FIG. 34, after cutting the pouch cell according to Experimental Example 1 in half, a capacity was measured while performing charge/discharge cycles (0.5 C), and it was checked whether an LED lamp electrically connected to the pouch cell according to Experimental Example 1 is turned on.

As shown in FIG. 34, it may be found that even when the pouch cell according to Experimental Example 1 is cut in half, the pouch cell according to Experimental Example 1 stably operated for 30 charge/discharge cycles or more.

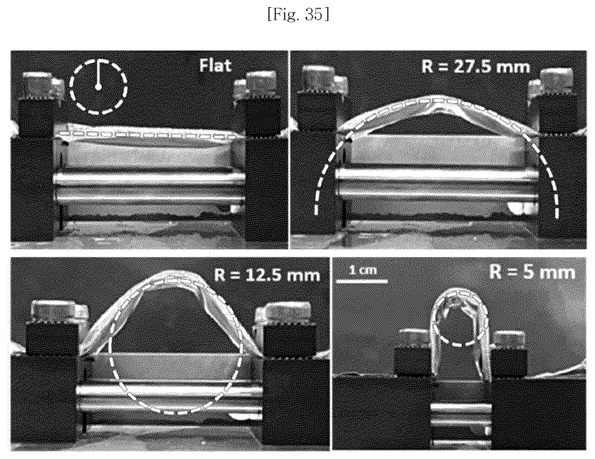

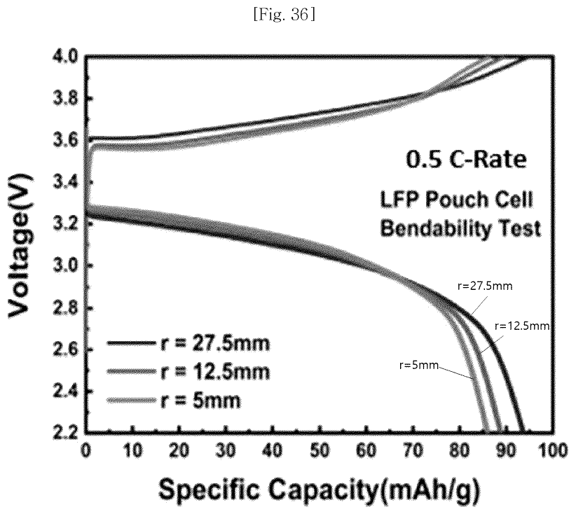

FIG. 35 shows actual photographs of the pouch cell according to Experimental Example 1 of the present invention, which is bent with various radii of curvature, and FIG. 36 is a graph for describing performance of the cell after bending the pouch cell according to Experimental Example 1 of the present invention with various radii of curvature.

Referring to FIG. 35, the pouch cell according to Experimental Example 1 was bent such that a radius of curvature of the pouch cell according to Experimental Example 1 is 27.5 mm, 12.5 mm, and 5 mm, and a photograph of an actual product was taken. Referring to FIG. 36, the pouch cell according to Experimental Example 1 was bent so as to have a radius of curvature of 27.5 mm, 12.5 mm, and 5 mm, and a voltage profile measured under a 5 C condition was shown in a graph.

As shown in FIGS. 35 and 36, it may be found that after the pouch cell according to Experimental Example 1 is bent so as to have various radii of curvature, the pouch cell according to Experimental Example 1 operated stably with almost no variation in a capacity and a voltage.

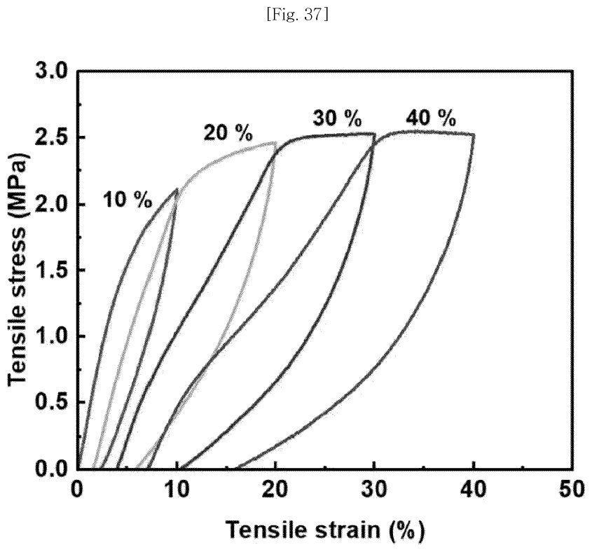

FIG. 37 shows stress-strain curves of a solid electrolyte layer according to an experimental example of the present invention.

Referring to FIG. 37, a freestanding solid electrolyte layer (After UV-60 s SPE; thickness 200 μm, size 3.0 cm×1.5 cm) was prepared by coating a glass substrate with the solid electrolyte source according to Experimental Example 1, evaporating a solvent, and performing irradiation with ultraviolet light (365 nm, 0.7 Wcm⁻², 60 seconds). In addition, the freestanding solid electrolyte layer was provided to a tension tester (Universal Testing Systems, UTM), and a recovery rate was measured by repeatedly applying and removing a load while gradually increasing uniaxial strain from 10% to 40% at a speed of 15 mm/min.

As shown in FIG. 37, it may be found that the solid electrolyte layer had a recovery rate of 75% or more at each uniaxial strain step. Therefore, the solid electrolyte layer may have excellent stretchability and mechanical stability, so that upon application to a lithium secondary battery, the solid electrolyte layer may effectively accommodate volumetric and morphological variations of a lithium metal.

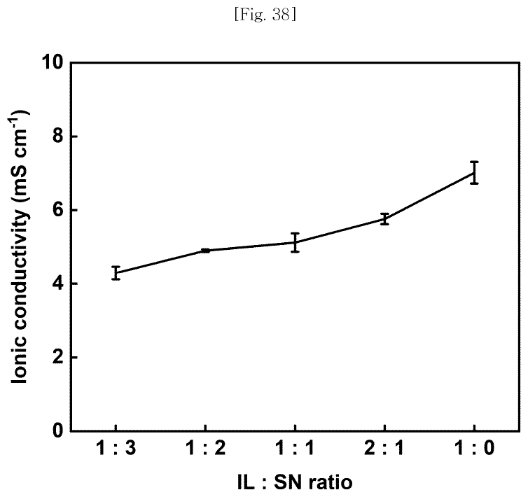

FIG. 38 is a graph for comparing ionic conductivity for freestanding solid electrolyte layers prepared by using solid electrolyte sources according to experimental examples of the present invention.

Referring to FIG. 38, a first solid electrolyte layer I1S2 was prepared by evaporating the solvent in the solid electrolyte source according to Experimental Example 1 and performing irradiation with ultraviolet light (365 nm, 0.7 W/cm², 60 seconds); a second solid electrolyte layer I1S3 was prepared by evaporating the solvent in the solid electrolyte source according to Experimental Example 1-1 and performing irradiation with ultraviolet light (365 nm, 0.7 W/cm², 60 seconds); a third solid electrolyte layer I1S1 was prepared by evaporating the solvent in the solid electrolyte source according to Experimental Example 1-2 and performing irradiation with ultraviolet light (365 nm, 0.7 W/cm², 60 seconds); a fourth solid electrolyte layer I2S1 was prepared by evaporating the solvent in the solid electrolyte source according to Experimental Example 1-3 and performing irradiation with ultraviolet light (365 rim, 0.7 W/cm², 60 seconds); and a fifth solid electrolyte layer I1S0 was prepared by evaporating the solvent in the solid electrolyte source according to Experimental Example 2 and performing irradiation with ultraviolet light (365 rim, 0.7 W/cm², 60 seconds). In addition, ionic conductivity was calculated for the first to fifth solid electrolyte layers at 30° C. by the method described above in FIG. 15.

As shown in FIG. 38, it may be found that the ionic conductivity of the first solid electrolyte layer was 4.90 mS/cm, the ionic conductivity of the second solid electrolyte layer was 4.29 mS/cm, the ionic conductivity of the third solid electrolyte layer was 5.12 mS/cm, the ionic conductivity of the fourth solid electrolyte layer was 5.76 mS/cm, and the ionic conductivity of the fifth solid electrolyte layer was 7.02 mS/cm.

Therefore, it may be found that as the weight ratio of the ionic liquid in the solid electrolyte source increases, the ionic conductivity of the solid electrolyte layer is gradually improved.

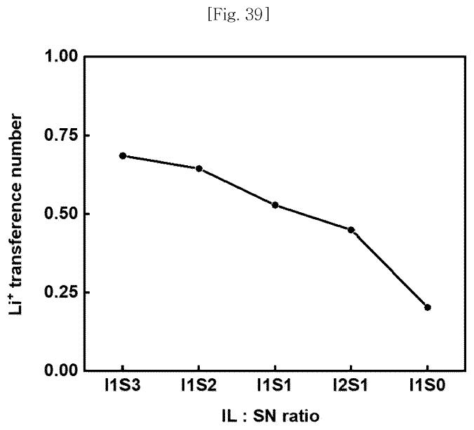

FIG. 39 is a graph for comparing lithium ion transference numbers t_{Li}⁺ for freestanding solid electrolyte layers prepared by using solid electrolyte sources according to experimental examples of the present invention.

Referring to FIG. 39, cells were prepared by arranging the first solid electrolyte layer I1S2, the second solid electrolyte layer I1S3, the third solid electrolyte layer I1S1, the fourth solid electrolyte layer I2S1, and the fifth solid electrolyte layer I1S0 described above in FIG. 38 between a pair of stainless steel electrodes, respectively, and a lithium ion transference number t_{Li}⁺ was calculated for the first to fifth solid electrolyte layers I1S2 to I1S0 at 30° C. by the method described above in FIG. 16.

As shown in FIG. 39, it may be found that the lithium ion transference number of the first solid electrolyte layer was 0.644, the lithium ion transference number of the second solid electrolyte layer was 0.686, the lithium ion transference number of the third solid electrolyte layer was 0.528, the lithium ion transference number of the fourth solid electrolyte layer was 0.449, and the lithium ion transference number of the fifth solid electrolyte layer was 0.203.

Therefore, it may be found that as the weight ratio of the succinonitrile in the solid electrolyte source increases, the lithium ion transference number of the solid electrolyte layer is gradually increased.

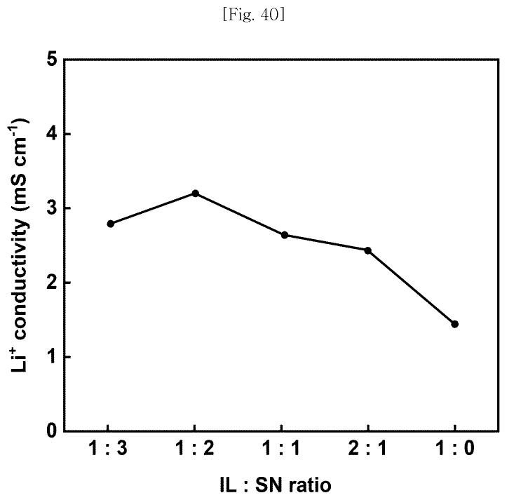

FIG. 40 is a graph for comparing lithium ion conductivity for freestanding solid electrolyte layers prepared by using solid electrolyte sources according to experimental examples of the present invention.

Referring to FIG. 40, lithium ion conductivity was calculated for the first to fifth solid electrolyte layers I1S2 to I1S0 by multiplying the ionic conductivity values of the first solid electrolyte layer I1S2, the second solid electrolyte layer I1S3, the third solid electrolyte layer I1S1, the fourth solid electrolyte layer I2S1, and the fifth solid electrolyte layer I1S0 described above in FIG. 38 by the lithium ion transference numbers t_{Li+} of the first solid electrolyte layer I1S2, the second solid electrolyte layer I1S3, the third solid electrolyte layer I111, the fourth solid electrolyte layer I2S1, and the fifth solid electrolyte layer I1S0 described above in FIG. 39.

As shown in FIG. 40, it may be found that the lithium ion conductivity of the first solid electrolyte layer was 3.16 mS/cm, the lithium ion conductivity of the second solid electrolyte layer was 2.94 mS/cm, the lithium ion conductivity of the third solid electrolyte layer was 2.71 mS/cm, the lithium ion conductivity of the fourth solid electrolyte layer was 2.59 mS/cm, and the lithium ion conductivity of the fifth solid electrolyte layer was 1.42 mS/cm.

Therefore, it may be found that the lithium ion conductivity of the first solid electrolyte layer was the highest.

Accordingly, in the method for manufacturing the curable composition (solid electrolyte source) according to the embodiment of the present disclosure, it may be found that a scheme of controlling the weight ratio of the ionic liquid electrolyte and the succinonitrile in the curable composition (solid electrolyte source) to be greater than 1:1 and less than 1:3 is a scheme of improving the lithium ion conductivity of the stretchable coating layer (solid electrolyte layer).

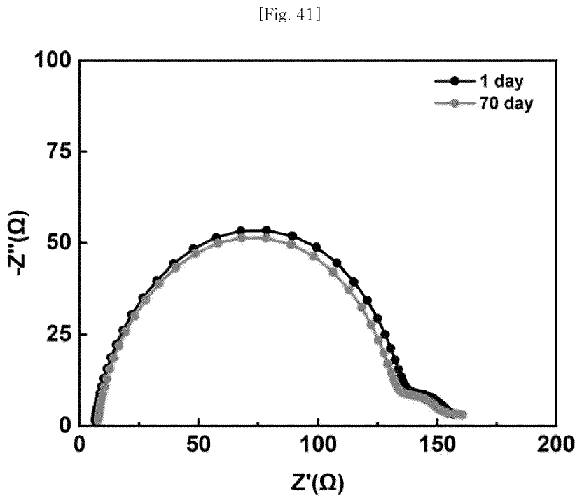

FIG. 41 is a graph for evaluating interfacial stability of a symmetric cell according to Experimental Example 2 of the present invention.

Referring to FIG. 41, interfacial resistance Rᵢ of the symmetric cell according to Experimental Example 2 was measured by using electrochemical impedance spectroscopy, and the interfacial resistance Rᵢ of the symmetric cell according to Experimental Example 2 was measured after the symmetric cell is left for 70 days.

As shown in FIG. 41, it may be found that the interfacial resistance of the symmetric cell according to Experimental Example 2 was 113Ω, and the interfacial resistance after being left for 70 days was slightly increased to 130Ω, which is still a low resistance value. The factor of the above configuration may be interpreted to be due to the solid electrolyte layer in the symmetric cell according to Experimental Example 2.

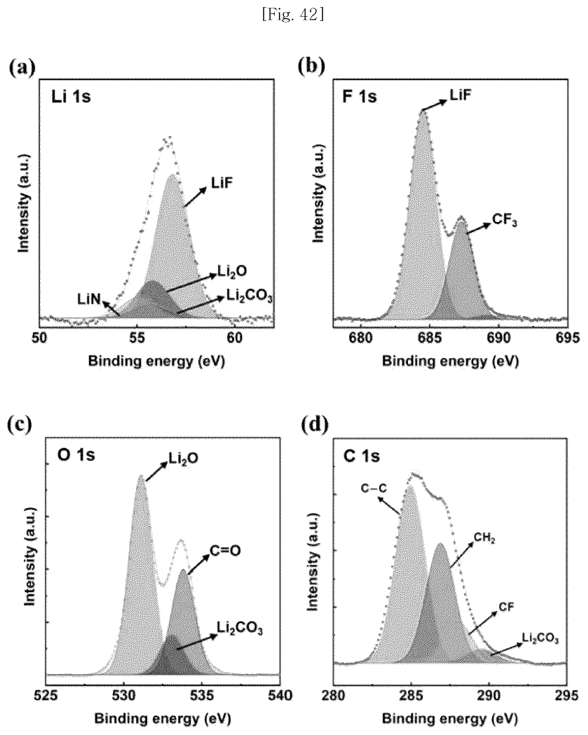

FIG. 42 is a view for describing XPS analysis results for an electrode surface after charge/discharge of the symmetric cell according to Experimental Example 2 of the present invention.

Referring to FIG. 42, the symmetric cell according to Experimental Example 2 was subjected to 100 charge/discharge cycles (0.1 mA/cm², 0.1 mAh/cm²), the symmetric cell was disassembled, and Li is, F 1s, O 1s, and C is spectra were analyzed for an electrode surface by XPS.

As shown in FIG. 42, it may be found that a LiF-rich solid electrolyte interface (SEI) was formed on the electrode surface of the symmetric cell according to Experimental Example 2. Therefore, as in the result described above in (c) of FIG. 21, it may be found that growth of dendrite on the electrode surface of the symmetric cell according to Experimental Example 2 was suppressed.

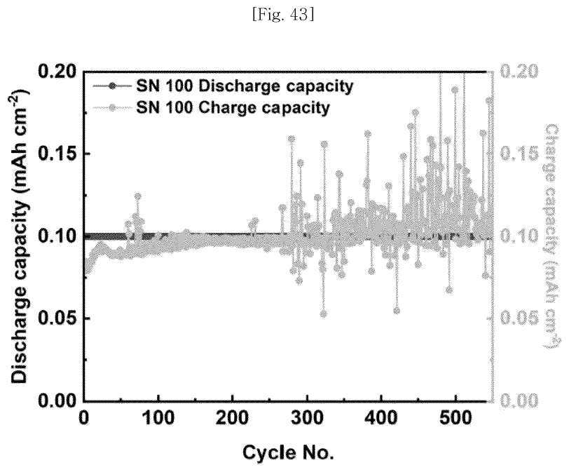

FIG. 43 is a graph for describing performance of a coin cell according to Experimental Example 5 of the present invention.

Referring to FIG. 43, a capacity of the coin cell according to Experimental Example 5 was measured while performing 500 charge/discharge cycles (0.1 mA/cm², 0.1 mAh/cm²).

As shown in FIG. 43, the coin cell according to Experimental Example 5 exhibited an overcharging phenomenon due to side reaction between the succinonitrile and the lithium metal in the solid electrolyte layer.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

### DESCRIPTION OF REFERENCE NUMERALS

1: Substrate
2: Positive electrode current collector
10: Positive electrode layer
100: Curable composition
101: Stretchable coating layer
110: Solvent
120: Fluorine-based polymer
130: Base solution
140: Lithium salt
150: Ionic liquid
160: Succinonitrile
170: Azide curing agent
180: Additive
200: Positive electrode
300: Negative electrode
400: Stretchable secondary battery

1. A method for manufacturing a curable composition, the method comprising:
preparing a base solution by dissolving a fluorine-based polymer in a solvent; and
preparing the curable composition by providing and dissolving lithium salt, an ionic liquid, succinonitrile, an azide-based curing agent, and an additive in the base solution.

2. The method of claim 1, wherein the solvent includes one of dimethyl carbonate, acetone, or acetonitrile.

3. The method of claim 1, wherein the fluorine-based polymer includes at least one of polyvinylidene fluoride, poly(vinylidene fluoride-co-hexafluoropropylene), polytetrafluoroethylene (PTFE), or tetrafluoroethylene-co-hexafluoropropylene.

4. The method of claim 1, wherein the azide-based curing agent includes at least one of 2,6-bis(4-azidobenzylidene)cyclohexanone, ethane-1,2-diyl bis(4-azido-2,3,5,6-tetrafluorobenzoate), polyoxyethylene bis(azide), or (2,2-bis(((4-azido-2,3,5,6-tetrafluorobenzoyl)oxy)methyl)propane-1,3-diyl bis(4-azido-2,3,5,6-tetrafluorobenzoate).

5. The method of claim 1, wherein the ionic liquid includes at least one of 1-ethyl-3-methylimidazolium bis(trifluoromethylsulfonyl) imide, 1-butyl-1-methylpyrrolidinium bis(fluorosulfonyl) imide, N-methyl-N-propylpiperidinium hexafluorophosphate, or tetraethylammonium tetrafluoroborate.

6. The method of claim 1, wherein the lithium salt includes lithium bis(trifluoromethanesulfonyl) imide, and
the additive includes fluoroethylene carbonate.

7. A method for manufacturing a curable composition, which includes preparing the curable composition by providing and dissolving lithium salt, an ionic liquid, succinonitrile, an azide-based curing agent, and an additive in a base solution in which a fluorine-based polymer is dissolved in a solvent,
wherein a chain of the fluorine-based polymer has fluidity upon swelling so that ionic conductivity of the fluorine-based polymer is improved,
the ionic liquid allows the fluorine-based polymer to swell so that the ionic conductivity of the fluorine-based polymer is improved,
the succinonitrile has a plastic crystal at a room temperature so that a lithium ion transference number is increased, and
the azide-based curing agent includes at least two azides.

8. The method of claim 7, wherein the azide of the azide-based curing agent is converted into a nitrene intermediate by ultraviolet light or heat, and
the nitrene intermediate reacts with the fluorine-based polymer, the succinonitrile, positive ions of the ionic liquid, and a C—H bond of the additive so as to form a secondary amine bond.

9. The method of claim 7, wherein ionic conductivity, a lithium ion transference number, and lithium ion conductivity of a stretchable coating layer formed by curing the curable composition are controlled according to a weight ratio of the ionic liquid and the succinonitrile in the curable composition.

10. The method of claim 9, wherein as the weight ratio of the ionic liquid in the curable composition increases, the ionic conductivity of the stretchable coating layer is gradually improved.

11. The method of claim 9, wherein as the weight ratio of the succinonitrile in the curable composition increases, the lithium ion transference number of the stretchable coating layer is gradually increased.

12. The method of claim 9, wherein the weight ratio of the ionic liquid and the succinonitrile in the curable composition is controlled to be greater than 1:1 and less than 1:3, so that the lithium ion conductivity of the stretchable coating layer is improved.

13. The method of claim 9, wherein the ionic liquid includes 1-ethyl-3-methylimidazolium bis(trifluoromethylsulfonyl) imide.

14. A stretchable coating layer in which a fluorine-based polymer, succinonitrile, positive ions of an ionic liquid, and an additive are crosslinked into a single network by a nitrene intermediate,
wherein ionic conductivity of the stretchable coating layer is greater than or equal to 4.90 mS/cm,
a lithium ion transference number (t_{Li+}) of the stretchable coating layer is greater than or equal to 0.644, and
lithium ion conductivity of the stretchable coating layer is greater than or equal to 3.16 mS/cm.

15. The stretchable coating layer of claim 14, wherein the fluorine-based polymer includes poly(vinylidene fluoride-co-hexafluoropropylene),
the ionic liquid includes 1-ethyl-3-methylimidazolium bis(trifluoromethylsulfonyl)imide,
the additive includes fluoroethylene carbonate, and
the stretchable coating layer further includes lithium salt.

16. The stretchable coating layer of claim 14,
wherein a Young's modulus value of the stretchable coating layer is greater than or equal to 10.2 MPa,
a maximum extension rate of the stretchable coating layer is greater than or equal to 120%,
a recovery rate is greater than or equal to 75% upon removal of a load after the stretchable coating layer is stretched by 40%, and
adhesive strength between the stretchable coating layer and lithium foil is stronger than adhesive strength between the stretchable coating layer and copper foil.
